(19) United States
(12) Patent Application Publication
(10) Pub. No.: US 2026/0094326 A1
(43) Pub. Date: Apr. 2, 2026

(54) Machine-Learned Models to Generate Content Including an Image with Text

(71) Applicant: Google LLC, Mountain View, CA (US)

(72) Inventors: Sourish Chaudhuri, San Francisco, CA (US); Terrance Paul McCartney, Pittsburgh, PA (US); Daniel V. Klein, Pittsburgh, PA (US)

(21) Appl. No.: 18/903,875

(22) Filed: Oct. 1, 2024

(51) Int. Cl. G06T 11/60; G06F 40/109

(52) U.S. Cl. CPC G06T 11/60; G06F 40/109

(57) ABSTRACT

A computing device for generating content includes one or more memories to store instructions and one or more processors to execute the instructions to perform operations, the operations including: receiving an input prompt requesting to generate content including an image with text; implementing one or more first machine-learned models configured to: determine, based on the input prompt, the text to be displayed in the image and one or more first features associated with the text, and determine one or more second features relating to generating an initial image which excludes the text; implementing one or more second machine-learned models configured to generate the initial image based on the one or more second features; and generating the content including the image with the text, based on the initial image generated via the one or more second machine-learned models and the one or more first features associated with the text.

### FIELD

This disclosure relates generally to machine learning processes and machine-learned devices and systems. More particularly, the disclosure relates to implementing a plurality of machine-learned models to improve content generation systems. For example, a content generation application or system can generate the content by applying one or more first machine-learned models to generate text and one or more second machine-learned models to generate an image or video, and forms the content which includes the image or video with the text.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Various methods exist for generating content based on a user input, prompt, or query. Some methods use large language models (LLMs) for generating text prompts for various subtasks, and the text prompts can be used with other models (e.g., text-to-image or text-to-video models) to generate content such as images or videos. However, these other models may not accurately output the content as the user intended or the content may suffer from various deficiencies (e.g., inaccurate translations of text appearing in the content, poor readability of text appearing in the content, nonsensical text appearing in the content, etc.).

### SUMMARY

Aspects and advantages of embodiments of the disclosure will be set forth in part in the following description, or can be learned from the description, or can be learned through practice of the embodiments.

Example aspects of the disclosure provide an example computing device that includes one or more processors and one or more example non-transitory computer-readable media storing instructions that are executable by the one or more processors to cause the computing device to perform example operations. In some implementations, the example operations can include receiving an input prompt requesting to generate content including an image with text; implementing one or more first machine-learned models configured to: determine, based on the input prompt, the text to be displayed in the image and one or more first features associated with the text, and determine one or more second features relating to generating an initial image which excludes the text; implementing one or more second machine-learned models configured to generate the initial image based on the one or more second features; and generating the content including the image with the text, based on the initial image generated via the one or more second machine-learned models and the one or more first features associated with the text.

In some implementations, the input prompt includes a request to display the text in a target language which is in a different language than the input prompt.

In some implementations, the one or more first machine-learned models are configured to determine the target language based on the input prompt and to convert the text to the target language.

In some implementations, the one or more first features associated with the text include at least one of: one or more text colors associated with the text, one or more text locations associated with the text, or one or more text styles associated with the text.

In some implementations, the one or more first features include one or more text styles associated with the content, and the operations further comprise determining one or more font types associated with the text based on the one or more text styles.

In some implementations, the one or more first machine-learned models are configured to determine the one or more text styles based on portions of the input prompt which indicate at least one of a tone, theme, or purpose of the content to be generated, and the one or more first machine-learned models are configured to limit a number of the one or more text styles determined by the one or more first machine-learned models to a predetermined number of text styles.

In some implementations, the one or more first features include one or more text locations associated with the text, and the one or more first machine-learned models are configured to determine whether the input prompt indicates the one or more text locations at which to position the text within the image.

In some implementations, when the one or more first machine-learned models determine the input prompt indicates the one or more text locations to position the text within the image, the one or more first machine-learned models are configured to determine the one or more second features include the one or more text locations, and the one or more second machine-learned models are configured to generate the initial image by positioning one or more entities within the initial image based on the one or more text locations.

In some implementations, when the one or more first machine-learned models determine the input prompt indicates the one or more text locations to position the text within the image, the one or more first machine-learned models are configured to determine the one or more second features include the one or more text locations, and the one or more second machine-learned models are configured to generate the initial image by colorizing at least a portion of the initial image based on the one or more text locations.

In some implementations, when the one or more first machine-learned models determine the input prompt does not indicate the one or more text locations to position the text within the image, the one or more first machine-learned models are configured to determine the one or more text locations based on the initial image generated by the one or more second machine-learned models.

In some implementations, the one or more first machine-learned models are configured to determine the one or more text locations based on at least one of a location of one or more entities appearing in the initial image or a colorization of the initial image.

In some implementations, when the one or more first machine-learned models determine the input prompt does not indicate the one or more text locations to position the text within the image, the one or more first machine-learned models are configured to position the text at a default location within the image.

In some implementations, the one or more first machine-learned models are configured to determine whether the input prompt indicates one or more text colors to apply to the text within the image, and when the one or more first machine-learned models determine the input prompt indicates the one or more text colors to apply to the text within the image, the one or more first machine-learned models determine the one or more first features include the one or more text colors to apply to the text within the image.

In some implementations, when the one or more first machine-learned models determine the input prompt indicates the one or more text colors to apply to the text within the image, the one or more first machine-learned models are configured to determine the one or more second features include the one or more text colors, and the one or more second machine-learned models are configured to generate the initial image by colorizing at least a portion of the initial image based on the one or more text colors.

In some implementations, when the one or more first machine-learned models determine the input prompt does not indicate the one or more text colors to apply to the text within the image, the one or more first machine-learned models are configured to determine the one or more text colors to apply to the text within the image, based on the initial image generated by the one or more second machine-learned models, and the one or more first machine-learned models determine the one or more first features include the one or more text colors to apply to the text within the image.

In some implementations, the one or more first machine-learned models include one or more text-to-text machine-learned models, and the one or more second machine-learned models include one or more text-to-image machine-learned models.

Example aspects of the disclosure provide an example computer-implemented method. In some implementations, the example computer-implemented method can include: receiving an input prompt requesting to generate content including an image with text; implementing one or more first machine-learned models to: determine, based on the input prompt, the text to be displayed in the image and one or more first features associated with the text, and determine one or more second features relating to generating an initial image which excludes the text; implementing one or more second machine-learned models to generate the initial image based on the one or more second features; and generating the content including the image with the text, based on the initial image generated via the one or more second machine-learned models and the one or more first features associated with the text.

In some implementations, the computer-implemented method includes implementing the one or more first machine-learned models to determine, based on the input prompt, a target language in which to display the text in the image, and to convert the text to the target language.

In some implementations, the computer-implemented method includes determining, one or more text styles based on portions of the input prompt which indicate at least one of a tone, theme, or purpose of the content to be generated; and determining one or more font types associated with the text based on the one or more text styles, wherein the one or more first features include the one or more text styles and the one or more font types.

The computer-implemented method may execute any of the operations of the computing device as described herein.

Example aspects of the disclosure provide one or more example non-transitory computer-readable media storing instructions that are executable by one or more processors to cause a computing system to perform example operations. In some implementations, the example operations can include receiving an input prompt requesting to generate content including an image with text; implementing one or more first machine-learned models to: determine, based on the input prompt, the text to be displayed in the image and one or more first features associated with the text, and determine one or more second features relating to generating an initial image which excludes the text; implementing one or more second machine-learned models to generate the initial image based on the one or more second features; and generating the content including the image with the text, based on the initial image generated via the one or more second machine-learned models and the one or more first features associated with the text.

The non-transitory computer-readable medium may store additional instructions to execute other aspects and operations of the computing device and computer-implemented method as described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

FIG. 1A is an example system, according to one or more example embodiments of the disclosure;

FIG. 1B is an example block diagram of a computing system, according to one or more example embodiments of the disclosure;

FIGS. 2A-2B each illustrate a flow diagram of an example, non-limiting computer-implemented method, according to one or more example embodiments of the disclosure;

FIG. 3A illustrates an example block diagram of a system including a content generation application, according to one or more example embodiments of the disclosure;

FIG. 3B illustrates an example block diagram of a system including a content generation application, according to one or more example embodiments of the disclosure;

FIGS. 4A-4C are example implementations of the method for generating content including an image and text based on an input prompt, by implementing a plurality of machine-learned models, according to one or more example embodiments of the disclosure;

FIG. 4D is an example image generated according to an existing method based on the input prompt;

FIGS. 5A-5C are example implementations of the method for generating content including an image and text based on an input prompt, by implementing a plurality of machine-learned models, according to one or more example embodiments of the disclosure;

FIG. 5D is an example image generated according to an existing method based on the input prompt;

FIG. 6 is a flow chart diagram illustrating an example method for training a machine-learned model according to example implementations of aspects of the disclosure;

FIG. 7 is a block diagram of an example processing flow for using machine-learned model(s) to process input(s) to generate output(s) according to example implementations of aspects of the disclosure;

FIG. 8 is a block diagram of an example sequence processing model according to example implementations of aspects of the disclosure;

FIG. 9 is a block diagram of an example technique for populating an example input sequence for processing by a sequence processing model according to example implementations of aspects of the disclosure;

FIG. 10 is a block diagram of an example model development platform according to example implementations of aspects of the disclosure;

FIG. 11 is a block diagram of an example training workflow for training a machine-learned model according to example implementations of aspects of the disclosure;

FIG. 12 is a block diagram of an inference system for operating one or more machine-learned model(s) to perform inference according to example implementations of aspects of the disclosure;

FIG. 13 is a block diagram of an example networked computing system according to example implementations of aspects of the disclosure;

FIG. 14 is a block diagram of an example computing device according to example implementations of aspects of the disclosure; and

FIG. 15 is a block diagram of an example computing device according to example implementations of aspects of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Text rendering for image generation can be leveraged to provide textual messages within images, which can then be utilized for graphics, cards, memes, advertising, and/or other content. Text can change or emphasize the meaning of an image. In some instances, text can convey information that is not already included within the image.

Existing image generation models can fail to accurately render text in the generated images. The text may not be what was requested, may be misspelled, may be omitted, and/or may not be legible. Further, the text may be placed in positions that may obscure a subject of the image.

According to the example computing systems and methods of the disclosure, machine-learned models are implemented to generate, based on a given prompt, an image which includes text. For example, the prompt can be processed with a first machine-learned model (e.g., a generative language model including a text-to-text machine-learned model) that is configured to split the prompt into different tasks including text-related tasks and image-related tasks. In some implementations, the text-related tasks may be performed by the first machine-learned model to generate a text output. In some implementations, the image-related tasks may be performed by a second machine-learned model (e.g., a generative image generation model including a text-to-image machine-learned model) that is configured to generate an initial image output. In some implementations, the text output may then be rendered into the initial image output to generate a final image output. In some implementations, the positioning, size, and/or font may be determined based on the prompt and/or the features of the initial image output. The final image output thus provides the image rendering capabilities of an image generation model while providing enhanced text rendering (e.g., in the form of overlays).

According to the example computing systems and methods of the disclosure, the task of image generation can be leveraged in various applications (e.g., entertainment, marketing, creative applications, etc.). By separating the tasks of image and text generation through the implementation of different models, each model can be leveraged for their varying strengths before rendering the final image output which integrates the text output with the initial image output. In particular, complex natural language processing tasks cannot be performed by image generation models, while splitting the tasks as described herein can provide for complex tasks to be performed without having to tune an image generation model for complex natural language processing tasks.

One or more technical benefits of the disclosure include the implementation of machine-learned models which generate content that satisfies the expectations of a users' intent as indicated by a prompt. The computing systems and methods described herein improve the quality of the generated output content by providing, for example, more accurate translations of text appearing in the final image output, more accurate placement and sizing of text within the final image output, more relevant initial image outputs, etc. The machine-learned models described herein can conserve computing resources including processing power, memory, network resources (e.g., bandwidth), etc., by providing a final image output that meets user expectations, reducing the need for additional requests by the user, and saving time and computing resources by not requiring the user to input additional prompts or edit existing prompts and thus avoiding the need for processing prompts and generating further inferences. Further, in some implementations the machine-learned models described herein can be embodied by pre-existing machine-learned models that are capable of processing prompts as described herein to generate the final image output. For example, enabling the reuse of a pre-existing machine-learned model with the new techniques described herein, can save or conserve storage on a computing device and/or time for training because it is not necessary to train and store a new model.

Therefore, aspects of the disclosure provide technical effects, benefits, and/or improvements in computing technology and the technology of content generation systems and machine-learned models, via one or more computing devices (e.g., a user computing device, a server computing system, and combinations thereof) which implement machine-learned models, as described herein.

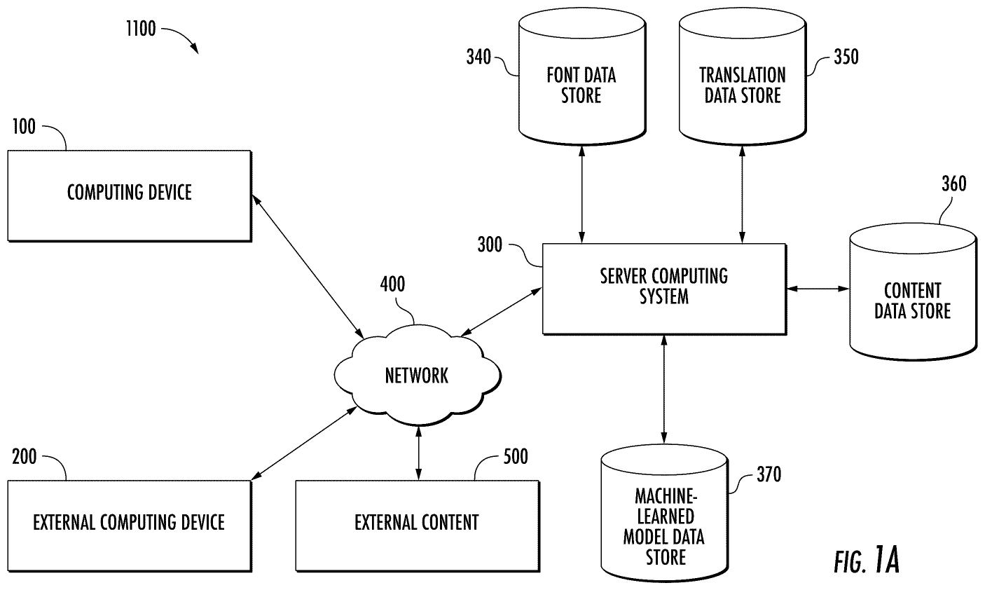

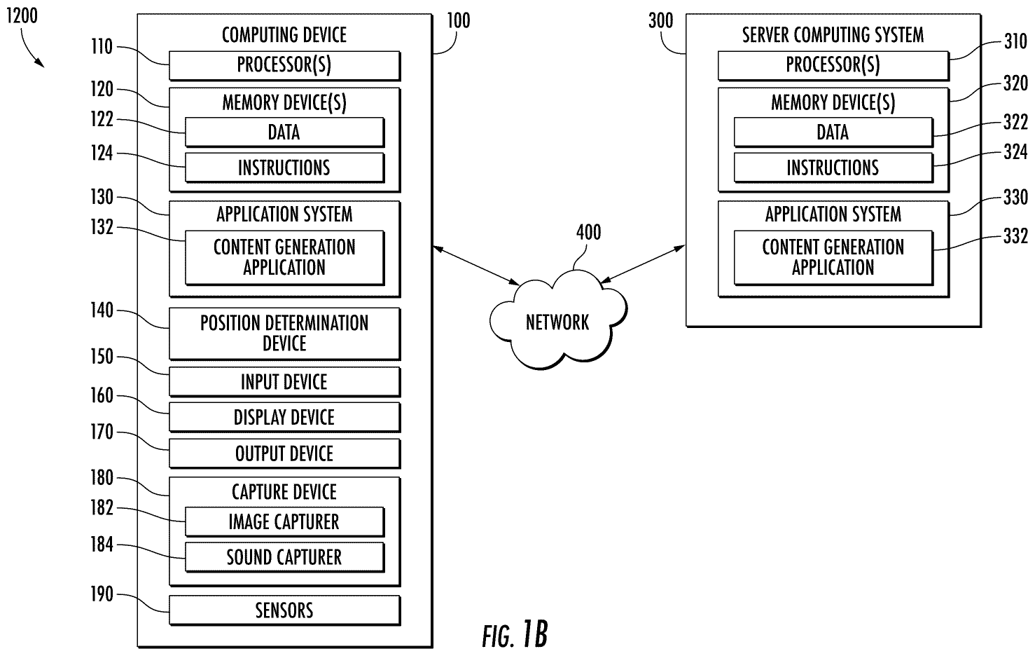

Referring now to the drawings, FIG. 1A is an example system according to one or more example embodiments of the disclosure. FIG. 1A illustrates an example of a system 1100 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a laptop, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can provide a tool for a content generation system (e.g., image content and/or video content) by which, via machine-learned models described herein, content such as an image or a video having text displayed therein, can be generated accurately according to an input prompt.

In some example embodiments, the server computing system 300 may obtain data from one or more of a font data store 340, a translation data store 350, a content data store 360, and a machine-learned model data store 370, to implement various operations and aspects of the application systems as disclosed herein. The font data store 340, translation data store 350, content data store 360, and machine-learned model data store 370 may be integrally provided with the server computing system 300 (e.g., as part of the one or more memory devices 320 of the server computing system 300) or may be separately (e.g., remotely) provided. Further, font data store 340, translation data store 350, content data store 360, and machine-learned model data store 370 can be combined as a single data store (database) or may include a plurality of respective data stores. Data stored in one data store (e.g., the translation data store 350) may overlap with some data stored in another data store (e.g., content data store 360). In some implementations, one data store (e.g., the machine-learned model data store 370) may reference data that is stored in another data store (e.g., the content data store 360).

In some implementations, the font data store 340 can store information relating to font types which can be applied to text to be included in generated content (e.g., image content and/or video content). For example, the font data store 340 can store a plurality of font types (e.g., a library of font types). The font types can be associated with Latin characters as well as various other languages (e.g., Bengali, Hindi, Katakana, Hiragania, etc.). In some implementations, each font type can be associated with contextual information (e.g., in a look-up table) that can indicate an appropriateness of a particular font type given certain contextual information. For example, the contextual information may be indicated by the input prompt which indicates a font style. The font data store 340 can also store information relating to possible font styles (e.g., active, artistic, awkward, business, calm, childlike, competent, cursive, cute, excited, fancy, futuristic, happy, innovative, loud, playful, rugged, sincere, sophisticated, stiff, vintage, etc.). In some implementations, the plurality of font styles can be associated with one or more font types (e.g., in a look-up table). For example, the font type “Ranchers” may be associated with font styles including “festive,” “fun,” and “happy” more than other font types. In some implementations, the font data store 340 can store information relating to font types including font size information, font color information, and font positioning information.

In some implementations, the information stored in the font data store 340 can be associated with and/or stored according to a particular user or a plurality of users, according to a particular content category, content genre, content context, time, location, content type, etc. In some implementations, the information stored in the font data store 340 can be associated with and/or stored according to a particular environment (e.g., outdoor, indoor, etc.). In some implementations, the information stored in the font data store 340 can be associated with and/or stored according to a particular entity that is associated with the content (e.g., an entity that requests the content to be generated, an entity that is to receive the content, an entity that appears in the content, etc.). For example, font colors may be selected or retrieved from the font data store 340 that match colors associated with a business that appears in the content.

In some implementations, the translation data store 350 can store information relating to translating text from a source language to a target language. In some implementations, the source language may correspond to the language utilized in the input prompt. In some implementations, the text to be translated can be obtained based on information which is provided in the input prompt. For example, the translation data store 350 can include information including dictionaries for a plurality of languages, grammatical structure information, one or more machine-learned models configured to translate text, etc.

In some implementations, the information stored in the translation data store 350 can be associated with and/or stored according to a particular user or a plurality of users, according to a particular content category, content genre, content context, time, location, content type, etc. In some implementations, the information stored in the translation data store 350 can be associated with and/or stored according to a particular entity that is associated with the content (e.g., an entity that requests the content to be generated, an entity that is to receive the content, an entity that appears in the content, etc.). For example, a translation to be applied to text may be selected or retrieved from the translation data store 350 that matches a language spoken or read by an intended audience of the content to be generated.

In some implementations, the content data store 360 can store data associated with content. For example, the content can include images, videos, textual descriptions (e.g., common phrases, mottos, slogans, etc.). In some implementations, the information stored in the content data store 360 can be associated with and/or stored according to a particular user or a plurality of users, according to a particular content category, content genre, content context, time, location, content type, content environment, etc. In some implementations, the information stored in the content data store 360 can be associated with and/or stored according to a particular entity that is associated with the content (e.g., an entity that requests the content to be generated, an entity that is to receive the content, an entity that appears in the content, etc.). For example, machine-learned models described herein can reference or retrieve content from the content data store 360 when generating the output image. The content which is referenced or retrieved from the content data store 360 may be associated with a location of the user who is to receive the content (e.g., an image of a lake near the location of the user may be referenced by the machine-learned models to generate the final output image).

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of applications, types of items, etc., that may be implemented across a variety of domains (e.g., healthcare, gaming, engineering/science, entertainment, travel, retail, etc.). The machine-learned models may include large language models and general, multimodal models (e.g., Gemini). The machine-learned models may include text-to-text large language models, text-to-image large language models, etc. The machine-learned models may include language models which have been trained using reinforcement learning from human feedback. The machine-learned models may include generative artificial intelligence (AI) models which may implement generative adversarial networks (GANs), transformers, variational autoencoders (VAEs), neural radiance fields (NeRFs), and the like.

External content 500 can be any form of external content including news articles, webpages, image files, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

FIG. 1B is an example block diagram of a computing system, according to one or more example embodiments of the disclosure. Referring now to FIG. 1B, example block diagrams of a system 1200 including a computing device 100 and server computing system 300 according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, an application system 130, a position determination device 140, an input device 150, a display device 160, an output device 170, a capture device 180, and one or more sensors 190. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement content generation application 132, and to execute the instructions to perform operations including receiving an input prompt requesting to generate content including an image with text; implementing one or more first machine-learned models configured to: determine, based on the input prompt, the text to be displayed in the image and one or more first features associated with the text, and determine one or more second features relating to generating an initial image which excludes the text; implementing one or more second machine-learned models configured to generate the initial image based on the one or more second features; and generating the content including the image with the text, based on the initial image generated via the one or more second machine-learned models and the one or more first features associated with the text, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement content generation application 332, and to execute the instructions to perform operations including receiving an input prompt requesting to generate content including an image with text; implementing one or more first machine-learned models configured to: determine, based on the input prompt, the text to be displayed in the image and one or more first features associated with the text, and determine one or more second features relating to generating an initial image which excludes the text; implementing one or more second machine-learned models configured to generate the initial image based on the one or more second features; and generating the content including the image with the text, based on the initial image generated via the one or more second machine-learned models and the one or more first features associated with the text, as described according to examples of the disclosure.

In some example embodiments, the computing device 100 includes an application system 130. For example, the application system 130 may include the content generation application 132. The application system 130 can include various other applications including search applications, gaming applications, document applications, text messaging applications, email applications, dictation applications, virtual keyboard applications, browser applications, map applications, social media applications, navigation applications, etc.

According to examples of the disclosure, the content generation application 132 may be executed by the computing device 100 to generate content according to an input prompt, via a plurality of machine-learned models. In some implementations, the content generation application 132 may be part of another application (e.g., a search application, health application, gaming application, etc.) or may be a standalone application. The content generation application 132 may be configured to be dynamically interactive according to various user inputs. Example implementations of the content generation application 132 are described herein, however the disclosure is not limited to these examples as various modifications may be made to the embodiments described herein.

In some examples, one or more aspects of the content generation application 132 may be implemented by the content generation application 332 of the server computing system 300 which may be remotely located, to provide a user of the computing device 100 a way to generate content according to an input prompt, via a plurality of machine-learned models. In some examples, one or more aspects of the content generation application 332 may be implemented by the content generation application 132 of the computing device 100, to generate content according to an input prompt, via a plurality of machine-learned models.

In some example embodiments, the computing device 100 includes a position determination device 140. Position determination device 140 can determine a current geographic location of the computing device 100 and communicate the geographic location to the server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the computing device 100. For example, in some implementations the content generation application 132 may be configured to utilize position information determined by the position determination device 140 in connection with generating the content requested via the input prompt (e.g., a position of a user providing the prompt and/or a position of one or more users who are to receive the content).

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the content generation application 132, for providing an input prompt to the content generation application 132, for providing feedback to the content generation application 132, for communicating with other users, for accepting or declining suggestions or recommendations provided by the computing device 100 with respect to content to be generated, etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to the content to be generated, to display information to a user relating to the content which has been generated, to display a user interface to a user for providing an input prompt to the content generation application 132, for providing information relating to a rationale for the generation of the content, etc. The display device 160 can be configured to provide, for presentation to a user, one or more user interface screens having user interface elements which are selectable by the user for generating content according to an input prompt, for providing feedback or instructions (guidance) to a user regarding operations for generating the content, for a user to provide feedback or information regarding operations for generating the content, etc.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to the operations for generating content according to an input prompt, including an output confirming the input prompt, an output relating to generating the content, an output for providing feedback or instructions (guidance) to a user regarding an item, etc.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the image capturer 182 can include one or more cameras having an imaging sensor (e.g., a complementary metal-oxide-semiconductor (CMOS) or charge-coupled device (CCD)). For example, the capture device 180 can include a sound capturer 184 (e.g., a microphone) which is configured to capture sound or audio (e.g., an audio recording). The media content captured by the capture device 180 may be transmitted to one or more of the server computing system 300, font data store 340, translation data store 350, content data store 360, and machine-learned model data store 370, for example, via network 400. For example, in some implementations, content which is captured by the capture device 180 may be provided as an input to one or more machine-learned models for various tasks associated with the content generation system (application system 130) and content generation application 132, described herein.

The computing device 100 may include one or more sensors 190. For example, the one or more sensors 190 may include an inertial measurement unit which includes one or more accelerometers and/or one or more gyroscopes. The one or more accelerometers and one or more gyroscopes may be used to capture motion information with respect to the computing device 100. The motion information obtained via the inertial measurement unit may be associated with the user when the computing device 100 is worn or carried by the user. For example, the one or more sensors 190 may include one or more optical sensors (e.g., one or more photoplethysmography (PPG) sensors, one or more electrocardiogram sensors, etc.). The one or more sensors 190 may also include other sensors such as a magnetometer, proximity sensor, Hall effect sensor, and the like. For example, in some implementations, content which is captured by the one or more sensors 190 may be provided as an input to one or more machine-learned models for various tasks associated with the content generation system (application system 130) and content generation application 132, described herein. For example, weather conditions (e.g., temperature, wind, precipitation, etc.) measured by various weather sensors of the computing device 100 may be referenced by one or more machine-learned models when an input prompt requests content to be generated which reflects the weather the user is experiencing.

In accordance with example embodiments of the disclosure, the server computing system 300 can include one or more processors 310 and one or more memory devices 320 as described herein. The server computing system 300 may also include an application system 330 which is similar to the application system 130 described herein.

For example, the application system 330 may include the content generation application 332 which performs functions similar to those described herein with respect to content generation application 132. In some implementations, one or more machine-learned models (e.g., generative machine-learned models, large language models, etc.) associated with the content generation application 332 may be configured to generate content according to an input prompt, as described according to examples of the disclosure. In some implementations, the content generation application 332 may be part of another application (e.g., a search application, health application, gaming application, etc.) or may be a standalone application.

For example, one or more machine-learned models (e.g., generative machine-learned models, large language models, etc.) associated with the application system 330 may be configured to perform a first action (e.g., implementing one or more machine-learned models to determine text features relating to the input prompt), while the computing device 100 may be configured to perform a second action (e.g., implementing one or more machine-learned models to generate an initial image output based on image features from the input prompt) to generate the final output image. For example, one or more machine-learned models (e.g., generative machine-learned models, large language models, etc.) associated with the application system 130 may be configured to perform a first action (e.g., implementing one or more machine-learned models to determine text features relating to the input prompt), while the server computing system 300 may be configured to perform a second action (e.g., implementing one or more machine-learned models to generate an initial image output based on image features from the input prompt) to generate the final output image.

Examples of the disclosure are directed to computer implemented methods for content generation systems including implementing a plurality of machine-learned models to generate content including an image having text appearing therein or a video having text appearing therein.

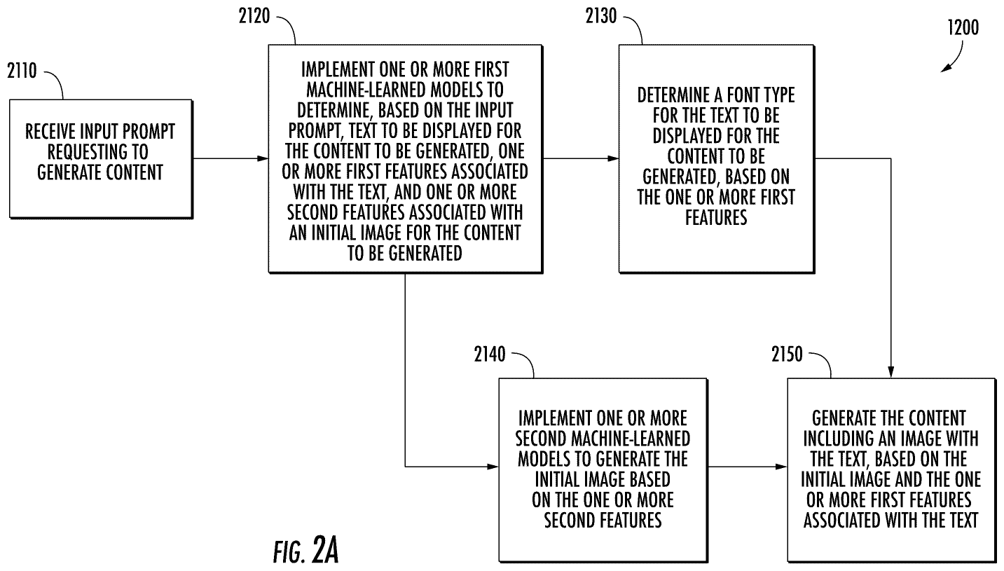

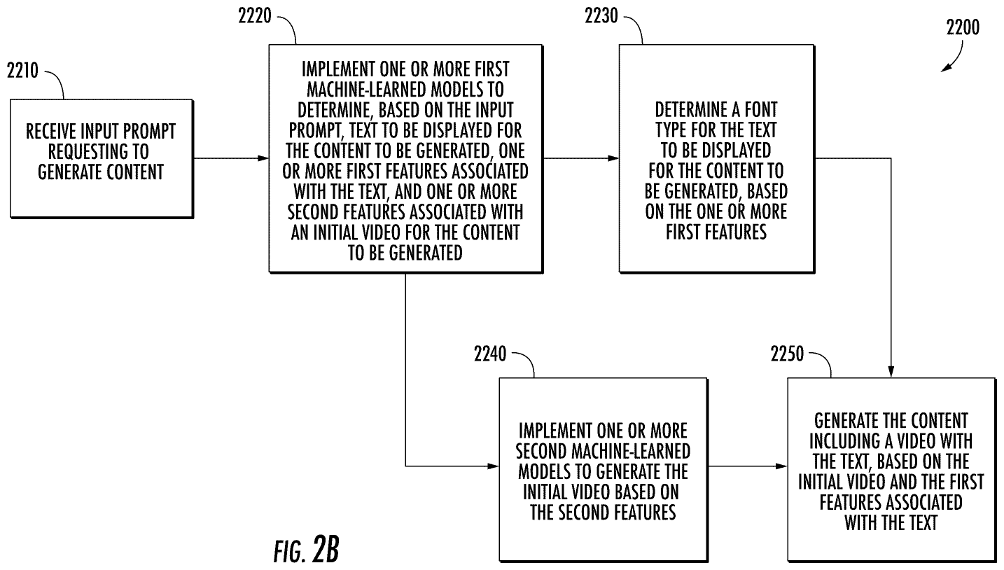

The flow diagram of FIG. 2A illustrates a method 2100 for generating content including an image and text based on an input prompt, by implementing a plurality of machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

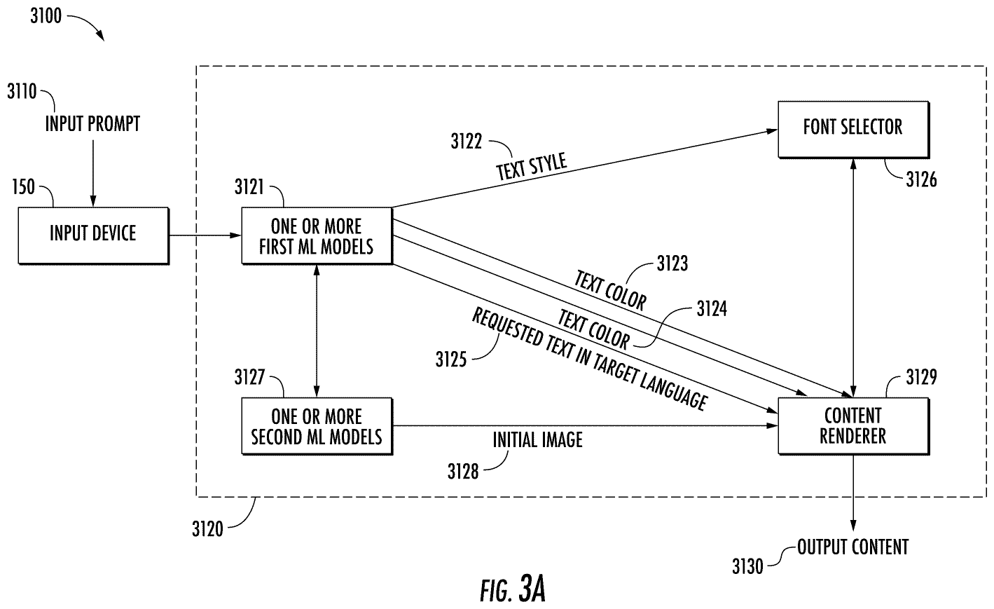

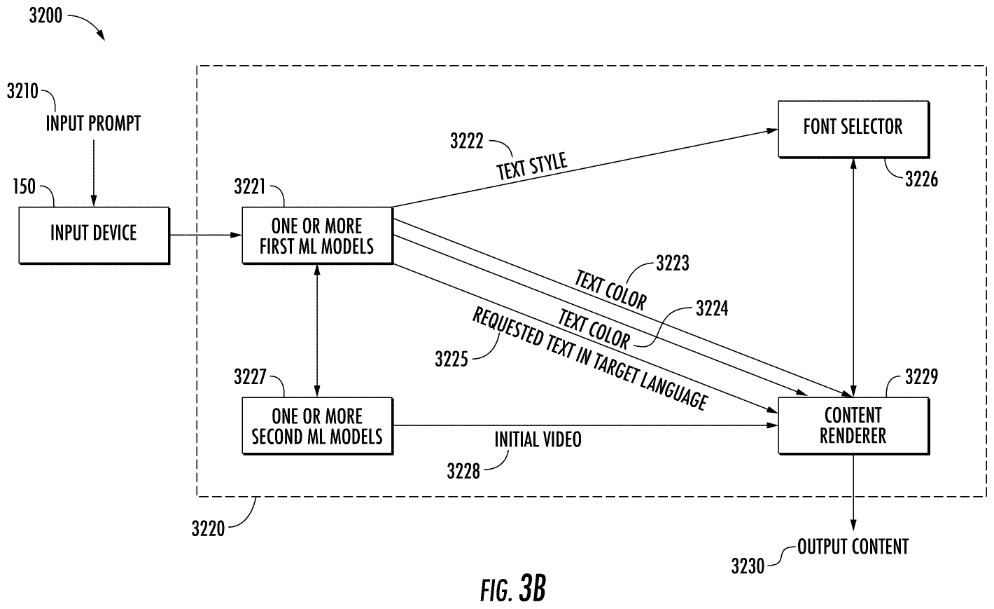

The operations of FIG. 2A will be explained with reference to FIG. 3A. FIG. 3A illustrates an example block diagram or architecture of a computing system (content generation system) 3100 including a content generation application 3120, according to one or more example embodiments of the disclosure.

Referring to FIG. 2A, at operation 2110 the method 2100 includes a computing device receiving an input prompt indicating a request to generate content. As described herein, the computing device may be embodied as computing device 100, server computing system 300, or combinations thereof. For example, in the computing system 3100 of FIG. 3A, in some implementations the input device 150 may be configured to receive the input prompt 3110. In some implementations the content generation application 3120 may be configured to receive the input prompt 3110 from a source other than the input device 150 (e.g., from the external computing device 200). The input prompt 3110 may be received through a voice input, text input, etc. An example prompt may include the query “Create a Happy New Year message in Finnish, with an image of fireworks visible in the night sky over a river.” According to the examples of the disclosure, the input prompt 3110 may include a query from a user to generate content that includes both text and an image (e.g., with text overlaid on the image). In some implementations, the text to be generated may be in a target language that is different from a source language (e.g., the language that is used to provide the input prompt).

At operation 2120 the method 2100 includes the computing device implementing one or more first machine-learned models to determine, based on the input prompt, the text to be displayed for the content to be generated (e.g., for an image), one or more first features associated with the text, and one or more second features associated with or relating to an initial image 3128 for the content to be generated. For example, in the computing system 3100 of FIG. 3A, the content generation application 3120 may include one or more first machine-learned models 3121 which are configured to determine one or more first features associated with the text for the content to be generated and one or more second features associated with an initial image 3128 for the content to be generated. In some implementations, the one or more first machine-learned models 3121 can include one or more text-to-text machine-learned models (e.g., one or more text-to-text large language models (LLMs), one or more text-to-text LLMs which have been fine-tuned using reinforcement learning from human feedback (RLHF), etc.).

The one or more first machine-learned models 3121 may be configured to parse the input prompt 3110 to identify the one or more first features associated with text for the content to be generated and the one or more second features associated with an image for the content to be generated. In some implementations, the one or more first machine-learned models 3121 may be configured to perform a task of determining the text which is to appear in the generated content (the final output image) based on the content of the input prompt 3110. For example, the one or more first machine-learned models 3121 may be tasked with determining what text is to appear in the image, as well as the particular manner in which that text is to be presented for display, given an input prompt. In some implementations, the one or more first features associated with the text for the content to be generated can include a text style, a text color, a text location, a text language, a font type, etc.

For example, the one or more first machine-learned models 3121 may be configured to parse the input prompt 3110 to extract or output text which is to be displayed in the generated content (final output image). In some implementations, the one or more first machine-learned models 3121 may be configured to limit the output text to a predetermined number of words or characters or tokens (e.g., five words, ten words, 100 characters, etc.). As an example, based on the example input prompt of “Create a Happy New Year message in Finnish, with an image of fireworks visible in the night sky over a river,” the one or more first machine-learned models 3121 may be configured to determine the text which is to be displayed in the generated content (final output image) and to limit the text to five words or less, and to output the text as “Happy New Year!” in the source language and as “Hyvää uutta vuotta!” in the target language of Finnish (e.g., according to a determination via the one or more first machine-learned models 3121 as to the applicable target language, based on the input prompt 3110).

For example, the one or more first machine-learned models 3121 may be configured to implement a first prompt to determine one or more text styles 3122 based on the input prompt 3110 and can be configured to extract or output descriptive text which describes the tone, mood, theme, purpose, or style of the generated content (final output image). In some implementations, the one or more first machine-learned models 3121 are configured to determine the one or more text styles 3122 based on portions of the input prompt which indicate at least one of a tone, mood, theme, purpose, or style of the content to be generated, and the one or more first machine-learned models 3121 are configured to limit a number of the one or more text styles determined by the one or more first machine-learned models 3121 to a predetermined number of text styles. An example prompt may be in the format of “given an input prompt, describe the text style requested.” In some implementations, the one or more first machine-learned models 3121 may be configured to limit the number of text styles to a predetermined number of text styles from among a plurality of available text styles or a predetermined number of words, which can be selected from (e.g., five, three, etc.). In some implementations, the text styles can include text styles including “Active,” “Artistic,” “Awkward,” “Business,” “Calm,” “Childlike,” “Competent,” “Cute,” “Excited,” “Fancy,” “Futuristic,” “Happy,” “Innovative,” “Loud,” “Playful,” “Rugged,” “Sincere,” “Sophisticated,” “Stiff,” “Vintage,” etc. However, these example text styles are merely examples, and the disclosure is not limited to these examples. The text styles that can be selected from may be stored in the font data store 340, for example. The one or more first machine-learned models 3121 may be trained to determine and output the one or more text styles 3122 which are appropriate based on the content of the input prompt 3110. For example, each of the text styles may be associated with particular contexts or words that might appear in the input prompt 3110 (e.g., the text style “happy” may be associated with words including happy, joyful, ecstatic, etc.). As an example, based on the example input prompt of “Create a Happy New Year message in Finnish, with an image of fireworks visible in the night sky over a river,” and a limit of three text styles or less (or three words or less), the one or more first machine-learned models 3121 may be configured to determine the one or more first features including the one or more text styles 3122 as “festive,” “fun,” and “happy.”

For example, the one or more first machine-learned models 3121 may be configured to implement a second prompt to determine one or more text colors 3123 based on the input prompt 3110 and can be configured to extract or output descriptive text which describes the color or colors that reflects or corresponds to the tone, mood, theme, or style of the text to be displayed in the generated content (final output image). An example prompt may be in the format of “given an input prompt, describe the text color requested.” In some implementations, the one or more first machine-learned models 3121 are configured to determine whether the input prompt 3110 indicates the one or more text colors 3123 to apply to the text within the image, and when the one or more first machine-learned models 3121 determines the input prompt 3110 indicates the one or more text colors 3123, the one or more first machine-learned models 3121 determine the one or more first features include the one or more text colors 3123. In some implementations, the one or more first machine-learned models 3121 may be configured to limit the number of text colors to a predetermined number of text colors from among a plurality of available text colors or a predetermined number of words, which can be selected from (e.g., three, two, one, etc.). In some implementations, the text colors that can be selected from may be stored in the font data store 340, for example. The one or more first machine-learned models 3121 may be trained to determine and output the one or more text colors 3123 which are appropriate based on the content of the input prompt 3110. In some implementations, the one or more first machine-learned models 3121 may be trained to determine and output the one or more text colors 3123 which are appropriate based additionally on other factors including a particular culture or location associated with the user, target audience, etc. For example, each of the text colors may be associated with particular contexts or words that might appear in the input prompt 3110 (e.g., the text color “yellow” may be associated with words including happy, joyful, ecstatic, etc., and the text color “white” may be associated with words including purity, perfection, beginnings, neutrality, etc.). As an example, based on the example input prompt of “Create a Happy New Year message in Finnish, with an image of fireworks visible in the night sky over a river,” and a limit of two text colors or less (or two words or less), the one or more first machine-learned models 3121 may be configured to determine the one or more first features including the one or more text colors 3123 as “white.” In some implementations, if the input prompt 3110 does not contain sufficient information to determine an appropriate color (e.g., a prediction probability of the one or more first machine-learned models 3121 is less than a threshold level), the one or more first machine-learned models 3121 may be configured to utilize a default text color (e.g., white). In some implementations, the one or more first machine-learned models 3121 may be configured to determine the text color additionally, or alternatively, based on the initial image generated by the one or more second machine-learned models 3127. For example, the one or more first machine-learned models 3121 may be configured to select a text color which provides the appropriate contrast with the image background that can clearly and effectively display the text (e.g., to improve readability of the text). For example, text with a light color (e.g., white, cream, light gray, robin's egg blue, etc.) may be more appropriate for images with a dark background while text with a dark color (e.g., black, navy blue, dark gray, etc.) may be more appropriate for images with a light background. In some implementations, when the one or more first machine-learned models 3121 determine the input prompt 3110 does not indicate the one or more text colors 3123 to apply to the text within the image, the one or more first machine-learned models 3121 are configured to determine the one or more text colors 3123 to apply to the text within the image, based on the initial image 3128 generated by the one or more second machine-learned models 3127, and the one or more first machine-learned models 3121 determine the one or more first features include the one or more text colors 3123 to apply to the text within the image. In some implementations, when the one or more first machine-learned models 3121 determine the input prompt 3110 indicates the one or more text colors 3123 to apply to the text within the image, the one or more first machine-learned models 3121 are configured to determine the one or more second features include the one or more text colors 3123, and the one or more second machine-learned models 3127 are configured to generate the initial image 3128 by colorizing at least a portion of the initial image 3128 based on the one or more text colors 3123.

For example, the one or more first machine-learned models 3121 may be configured to implement a third prompt to determine one or more text locations 3124 based on the input prompt 3110 and can extract or output descriptive text which describes the location or locations that reflects or corresponds to the intent of the request for locating the text to be displayed in the generated content (final output image) at a particular location. An example prompt may be in the format of “given an input prompt, describe the text location requested.” Another example prompt may be in the format of “given an input prompt, describe the text location requested, and if a location is not specified, determine an appropriate location of the text based on the content of the initial image.” In some implementations, the one or more first machine-learned models 3121 may be configured to specify the location of the text based on features of the initial image. For example, the one or more first machine-learned models 3121 may be configured to avoid placing the text over the face of a subject in the initial image when the initial image includes people. In some implementations, when the input prompt 3110 specifies a location for the text, the one or more first machine-learned models 3121 may be configured to locate the text at the specified location. Further, in some implementations, the one or more first machine-learned models 3121 may be configured to provide, as an input to the one or more second machine-learned models 3127, information indicating where the text is to be located in the image and to allow space in the initial image for the text to be placed. For example, if the input prompt 3110 specifies a location of the text as the top of the image, the one or more second machine-learned models 3127 may be configured to generate the initial image 3128 with space at the top of the image for the text to be located. Further, the top portion of the initial image 3128 may be provided with an appropriate image background color which provides the appropriate contrast with the text that can clearly and effectively display the text.

As described herein, the one or more first features can include one or more text locations associated with the text. The one or more first machine-learned models 3121 are configured to determine whether the input prompt 3110 indicates the one or more text locations 3124 at which to position the text within the image. In some implementations, the one or more first machine-learned models 3121 may be configured to determine the one or more text locations 3124 based on at least one of a location of one or more entities (e.g., foreground objects, people, buildings, etc.) appearing in the initial image 3128 or a colorization of the initial image 3128. For example, the text may be positioned so that the text does not obscure or cover the entities. For example, the text may be positioned at a location such that the color of the image does not negatively affect the readability of the text (e.g., avoiding positioning blue text over a blue background image).

As an example, based on the example input prompt of “Create a Happy New Year message in Finnish, with an image of fireworks visible in the night sky over a river,” the one or more first machine-learned models 3121 may be configured to determine the one or more first features including the one or more text locations 3124 as “not specified.” In some implementations, if the input prompt 3110 does not contain sufficient information to determine an appropriate location (e.g., a prediction probability of the one or more first machine-learned models 3121 is less than a threshold level), or is not specified by the input prompt 3110, the one or more first machine-learned models 3121 may be configured to utilize a default text location within the image (e.g., the bottom of the image, the top of the image, etc.). In some implementations, the one or more first machine-learned models 3121 may be configured to determine the text location additionally, or alternatively, based on the initial image 3128 generated by the one or more second machine-learned models 3127. For example, the one or more first machine-learned models 3121 may be configured to select a text location which provides the appropriate contrast with the image background that can clearly and effectively display the text (e.g., to improve readability of the text). For example, text with a light color (e.g., white, cream, light gray, etc.) may be located at a part of the image having a dark background while text with a dark color (e.g., black, navy blue, dark gray, etc.) may be located at a part of the image with a light background.

For example, the one or more first machine-learned models 3121 may be configured to implement a fourth prompt to determine the requested text in a target language 3125 based on the input prompt 3110 and can be configured to extract or output descriptive text that reflects or corresponds to the intent of the request for the text to be displayed in the generated content (final output image) in a particular (target) language. An example prompt may be in the format of “given an input prompt, describe the language that the text is to be presented in.” Another example prompt may be in the format of “given an input prompt, determine if the request indicates that the text is to be presented in a target language, and if so, translate the text to the target language.” In some implementations, the one or more first machine-learned models 3121 may be configured to determine if the input prompt 3110 includes a request to present the text in another language, for example, when the input prompt 3110 refers to the name of a known language (e.g., a language stored in translation data store 350). In some implementations, when the input prompt 3110 specifies a target language for the text, the one or more first machine-learned models 3121 may be configured to convert (e.g., translate or generate) the text (e.g., with reference to translation data store 350), or may be configured to implement one or more other machine-learned models which are trained to convert text to other languages (e.g., by utilizing a particular machine-learned model stored in the machine-learned model data store 370).

As an example, based on the example input prompt of “Create a Happy New Year message in Finnish, with an image of fireworks visible in the night sky over a river,” the one or more first machine-learned models 3121 may be configured to determine the one or more first features including the requested text in a target language 3125 as the target language of “Finnish” and the converted target language text as “Hyvää uutta vuotta!” based on a source language text of “Happy new year!”. In some implementations, if the input prompt 3110 does not contain sufficient information to determine an appropriate target language (e.g., a prediction probability of the one or more first machine-learned models 3121 is less than a threshold level), or is not specified by the input prompt 3110, the one or more first machine-learned models 3121 may be configured to utilize a default language (e.g., the language of the input prompt 3110, a known language of the user providing the input prompt 3110, a known language of a target audience, etc.).

At operation 2130 the method 2100 includes the computing device determining one or more font types for the text to be displayed for the content to be generated, based on the first features. For example, in the computing system 3100 of FIG. 3A, the content generation application 3120 may include a font selector 3126 which is configured to determine one or more particular font types to be applied to the text which is to be displayed in the content to be generated (e.g., the final output image), based on the one or more text styles 3122 associated with the text and content. In some implementations, the font selector 3126 may be configured to implement a heuristic similarity matching algorithm to determine one or more particular font types based on the one or more text styles 3122. In some implementations, the font selector 3126 may be configured to implement one or more font type machine-learned models to determine a particular font type based on the one or more text styles 3122. For example, the one or more font type machine-learned models may be trained to identify an appropriate font type based on example font types which are associated with certain descriptions. As an example, based on the one or more text styles 3122 corresponding to “festive,” “fun,” and “happy,” the font selector 3126 (e.g., via the heuristic similarity matching algorithm, one or more font type machine-learned models, etc.) may be configured to identify the font type of “Ranchers” as the appropriate font type for the text to be included in the content to be generated. For example, a plurality of font types from which the font type can be selected may be stored at the font data store 340.

At operation 2140 the method 2100 includes the computing device implementing one or more second machine-learned models to generate the image based on the one or more second features. For example, in the computing system 3100 of FIG. 3A, the content generation application 3120 may include the one or more second machine-learned models 3127 which are configured to generate an initial image 3128 based on the input prompt 3110 and based on the second features (e.g., a prompt for generating the initial image 3128 determined by the one or more first machine-learned models 3121). In some implementations, the one or more first machine-learned models 3121 may be configured to, based on the content of the input prompt 3110, perform a task of determining a prompt to be provided to the one or more second machine-learned models 3127 for generating an initial image which forms part of the generated output content (the final output image) 3130. For example, the one or more first machine-learned models 3121 may be tasked with, given the input prompt 3110, determining what should appear in an initial image, without reference to any of the text that is to later be included in the generated content. In some implementations, the one or more second features associated with the initial image for the content to be generated can include information from the input prompt 3110 to be used for generating the initial image 3128, for example, based on the text from the input prompt 3110. For example, the one or more first machine-learned models 3121 may be configured to parse the input prompt 3110 to determine which portions of the input prompt 3110 are directed to the text to be displayed in the generated content (e.g., including the one or more first features described herein) and which portions of the input prompt 3110 are directed to the initial image 3128 to be displayed in the generated content (e.g., including the one or more second features described herein). That is, the one or more first machine-learned models 3121 may be configured to exclude at least some of the one or more first features from being provided as an input to the one or more second machine-learned models 3127 for generating the initial image 3128 and be configured to exclude the text which is to be displayed in the generated content from being provided as an input to the one or more second machine-learned models 3127 for generating the initial image 3128. As an example, based on the example input prompt 3110 of “Create a Happy New Year message in Finnish, with an image of fireworks visible in the night sky over a river,” the one or more first machine-learned models 3121 may be configured to determine the one or more second features associated with the initial image for the content to be generated corresponds to “fireworks exploding in the night sky over a river.” Further, the one or more first machine-learned models 3121 may be configured to generate the prompt to be provided to the one or more second machine-learned models 3127 as “Generate: fireworks exploding in the night sky over a river.”

In some implementations when the one or more first machine-learned models 3121 determine the input prompt 3110 indicates the one or more text locations to position the text within the image, the one or more first machine-learned models 3121 may be configured to determine the one or more second features include the one or more text locations, and the one or more second machine-learned models 3127 may be configured to generate the initial image 3128 by colorizing at least a portion of the initial image based on the one or more text locations. For example, portions of the initial image 3128 may be shaded or colored so that the text can appear clearly in the final output image. In some implementations, when the one or more first machine-learned models 3121 determine the input prompt 3110 indicates the one or more text locations to position the text within the image, the one or more first machine-learned models 3121 may be configured to determine the one or more second features include the one or more text locations, and the one or more second machine-learned models 3127 may be configured to generate the initial image 3128 by positioning one or more entities (e.g., foreground objects, people, buildings, etc.) within the initial image 3128 based on the one or more text locations. For example, the entities may be positioned such that the text is located in a manner that does not obscure or cover the entities.

In some implementations, the one or more second machine-learned models 3127 can include one or more text-to-image machine-learned models (e.g., one or more text-to-image large language models (LLMs), one or more text-to-image LLMs which have been fine-tuned using reinforcement learning from human feedback (RLHF), etc.). The one or more second machine-learned models 3127 may be configured to generate, based on the prompt provided by the one or more first machine-learned models 3121, the initial image 3128. For example, the one or more second machine-learned models 3127 may be configured to generate the initial image 3128 according to known methods (e.g., using a generative model such as a generative adversarial network (GAN) or a diffusion model). For example, the one or more second machine-learned models 3127 which generate the initial image 3128 can be implemented using existing generative text-to-image models.

At operation 2150 the method 2100 includes the computing device generating content including the initial image and the text, based on the first features associated with the text. For example, in the computing system 3100 of FIG. 3A, the content generation application 3120 may include the content renderer 3129 which is configured to receive a plurality of inputs to generate the output content (e.g., the final output image) 3130. The plurality of inputs can include the initial image 3128 and the first features which can include the font type determined by the font selector 3126 to be applied to the text, the one or more text colors 3123 to be applied to the text, the one or more text locations 3124 to be applied to the text, the requested text in the target language 3125, etc. The content renderer 3129 may be configured to overlay the text (or converted text as applicable) onto the initial image 3128, for example, at the location specified by the one or more text locations 3124, using the one or more text colors 3123, and the font type determined by the font selector 3126. In some implementations, the first features may further specify a size of the text, or the size of the text may be specified according to the information associated with the font type. In some implementations, the one or more first machine-learned models 3221 and/or the content renderer 3229 may be configured to apply other visual effects to the text including animation effects, shading effects, highlighting effects, etc. In some implementations, the content renderer 3129 may be configured to blend the text with the underlying initial image 3128 (e.g., using a suitable blending operation such as alpha blending). Other methods may be applied or implemented to render or generate the final output image which is formed of a composition of the initial image 3128 and the text. As an example, based on the example input prompt of “Create a Happy New Year message in Finnish, with an image of fireworks visible in the night sky over a river,” the text to be displayed may be determined by the one or more first machine-learned models 3121 as “Happy New Year” and the translated text may be determined by the one or more first machine-learned models 3121 as “Hyvää uutta vuotta!” in the target language of Finnish and the initial image may correspond to an image of fireworks exploding over water at night. In some implementations, the text to be displayed may be user specified or user suggested as “Happy New Year” and the converted (e.g., translated or generated) text may be determined by the one or more first machine-learned models 3121 based on the text specified or suggested by the user as “Hyvää uutta vuotta!” in the target language of Finnish and the initial image may correspond to an image of fireworks exploding over water at night. In some implementations, the one or more first machine-learned models 3121 may be configured to construct (e.g., translate or generate) a literal translation of the text to be displayed or a non-literal translation of the text to be displayed. The generated content (the final output image) may correspond to the initial image with “Hyvää uutta vuotta!” in white text overlaid on an upper portion of the initial image.

The flow diagram of FIG. 2B illustrates a method 2200 for generating content including a video and text based on an input prompt, by implementing a plurality of machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The operations of the method 2200 depicted in FIG. 2B will be explained with reference to FIG. 3B. FIG. 3B illustrates an example block diagram or architecture of a computing system (content generation system) 3200 including a content generation application 3220, according to one or more example embodiments of the disclosure. Generally, the method 2200 depicted in FIG. 2B of generating content including a video and text based on an input prompt, by implementing a plurality of machine-learned models, may be performed in a manner similar to that of the method 2100 depicted in FIG. 2A, except that an initial video is generated rather than an initial image. In some implementations, aspects of the method 2100 (e.g., text location placement, text color determination, etc.) may be performed on a per image frame basis with respect to image frame comprising the video. Further, while FIGS. 3A and 3B depict separate computing systems (content generation systems) 3100, 3200 including different content generation applications 3120, 3220 it would be understood that in some implementations a single computing system (content generation system) can include a single content generation application that performs the operations of the content generation applications 3120, 3220 or can include both content generation applications 3120, 3220.

Referring to FIG. 2B, at operation 2210 the method 2200 includes a computing device receiving an input prompt indicating a request to generate content. As described herein, the computing device may be embodied as computing device 100, server computing system 300, or combinations thereof. For example, in the computing system 3200 of FIG. 3B, in some implementations the input device 150 may be configured to receive the input prompt 3210. In some implementations the content generation application 3220 may be configured to receive the input prompt 3210 from a source other than the input device 150 (e.g., from the external computing device 200). The input prompt 3210 may be received through a voice input, text input, etc. Operation 2210 may be similar to operation 2110 from FIG. 2A and therefore a repeated description will be omitted for the sake of brevity, except that the input prompt 3210 may include a query to generate content that includes both text and a video rather than text and an image. In some implementations, the text to be generated may be in a target language that is different from a source language (e.g., the language that is used provide the input prompt).

At operation 2220 the method 2200 includes the computing device implementing one or more first machine-learned models to determine, based on the input prompt, text to be displayed for the content to be generated, one or more first features associated with the text, and one or more second features associated with an initial video 3228 for the content to be generated. For example, in the computing system 3200 of FIG. 3B, the content generation application 3220 may include one or more first machine-learned models 3221 which are configured to determine one or more first features associated with text for the content to be generated and one or more second features associated with an initial video 3228 for the content to be generated. In some implementations, the one or more first machine-learned models 3221 can include one or more text-to-text machine-learned models (e.g., one or more text-to-text large language models (LLMs), one or more text-to-text LLMs which have been fine-tuned using reinforcement learning from human feedback (RLHF), etc.).

The one or more first machine-learned models 3221 may be configured to parse the input prompt 3210 to identify the one or more first features associated with text for the content to be generated and the one or more second features associated with the initial video 3228 for the content to be generated. The one or more first machine-learned models 3221 may be configured to identify the text and the first features (e.g., the one or more text styles 3222, the one or more text colors 3223, the one or more text locations 3224, the request text in the target language 3225, etc.) in a manner similar to how the one or more first machine-learned models 3121 of FIG. 2A determines the first features including the one or more text styles 3222, the one or more text colors 3123, the one or more text locations 3124, and the requested text in the target language 3125, etc. Therefore, a repeated description thereof will be omitted for the sake of brevity. Likewise, the one or more first machine-learned models 3221 may be configured to identify the second features (e.g., features for forming the prompt for generating the video based on text included in the input prompt 3210) in a manner similar to how the one or more first machine-learned models 3121 of FIG. 2A determines the second features for generating an initial image as described herein. Therefore, a repeated description thereof will be omitted for the sake of brevity.

At operation 2230 the method 2200 includes the computing device determining a font type for the text to be displayed for the content to be generated, based on the first features. For example, in the computing system 3200 of FIG. 3B, the content generation application 3220 may include a font selector 3226 which is configured to determine a particular font type to be applied to the text which is to be displayed in the content to be generated (e.g., the final output video). The font selector 3226 may be configured to determine the particular font type in a manner similar to how the font selector 3126 of FIG. 2A determines the particular font type as described herein. Therefore, a repeated description thereof will be omitted for the sake of brevity.

At operation 2240 the method 2200 includes the computing device implementing one or more second machine-learned models to generate the initial video based on the one or more second features. For example, in the computing system 3200 of FIG. 3B, the content generation application 3220 may include the one or more second machine-learned models 3227 which are configured to generate an initial video 3228 based on the input prompt 3210 and based on the second features (e.g., a prompt for generating the initial video 3228 determined by the one or more first machine-learned models 3221). In some implementations, the one or more first machine-learned models 3221 may be configured to, based on the content of the input prompt 3210, perform a task of determining a prompt to be provided to the one or more second machine-learned models 3227 for generating an initial video which forms part of the generated output content (the final output video) 3230. For example, the one or more first machine-learned models 3221 may be tasked with, given the input prompt 3210, determining what should appear in an initial video, without reference to any of the text that is to later be included in the generated content. In some implementations, the one or more second features associated with the initial video for the content to be generated can include information from the input prompt 3210 to be used for generating the initial video 3228, for example, based on the text from the input prompt 3210. For example, the one or more first machine-learned models 3221 may be configured to parse the input prompt 3210 to determine which portions of the input prompt 3210 are directed to the text to be displayed in the generated content (e.g., including the one or more first features described herein) and which portions of the input prompt 3210 are directed to the initial video 3228 to be displayed in the generated content (e.g., including the one or more second features described herein). That is, the one or more first machine-learned models 3221 may be configured to exclude at least some of the one or more first features from being provided as an input to the one or more second machine-learned models 3227 for generating the initial video 3228 and be configured to exclude the text which is to be displayed in the generated content from being provided as an input to the one or more second machine-learned models 3227 for generating the initial video 3228.

In some implementations, the one or more second machine-learned models 3227 can include one or more text-to-video machine-learned models (e.g., one or more text-to-video large language models (LLMs), one or more text-to-video LLMs which have been fine-tuned using reinforcement learning from human feedback (RLHF), etc.). The one or more second machine-learned models 3227 may be configured to generate, based on the prompt provided by the one or more first machine-learned models 3221, the initial video 3228. For example, the one or more second machine-learned models 3227 may be configured to generate the initial video 3228 according to known methods (e.g., using a generative model such as a generative adversarial network (GAN) or a diffusion model). For example, the one or more second machine-learned models 3227 which generate the initial video 3228 can be implemented using existing generative text-to-video models.

At operation 2250 the method 2200 includes the computing device generating content including the initial video and the text, based on the first features associated with the text. For example, in the computing system 3200 of FIG. 3B, the content generation application 3220 may include the content renderer 3229 which is configured to receive a plurality of inputs to generate the output content (e.g., the final output video) 3230. The plurality of inputs can include the initial video 3228 and the first features which can include the font type determined by the font selector 3226 to be applied to the text, the one or more text colors 3223 to be applied to the text, the one or more text locations 3224 to be applied to the text, the requested text in the target language 3225, etc. The content renderer 3229 may be configured to overlay the text (or converted text as applicable) onto the initial video 3228, for example, at the location specified by the one or more text locations 3224, using the one or more text colors 3223, and the font type determined by the font selector 3226. In some implementations, the first features may further specify a size of the text, or the size of the text may be specified according to the information associated with the font type. In some implementations, the content renderer 3229 may be configured to blend the text with the underlying initial video 3228 (e.g., using a suitable blending operation such as alpha blending). In some implementations, the one or more first machine-learned models 3221 and/or the content renderer 3229 may be configured to apply other visual effects to the text including animation effects, shading effects, highlighting effects, etc. In some implementations, the content renderer 3129 may be configured to blend the text with the underlying initial image 3128 (e.g., using a suitable blending operation such as alpha blending). Other methods may be applied or implemented to render or generate the final output video which is formed of a composition of the initial video 3228 and the text.

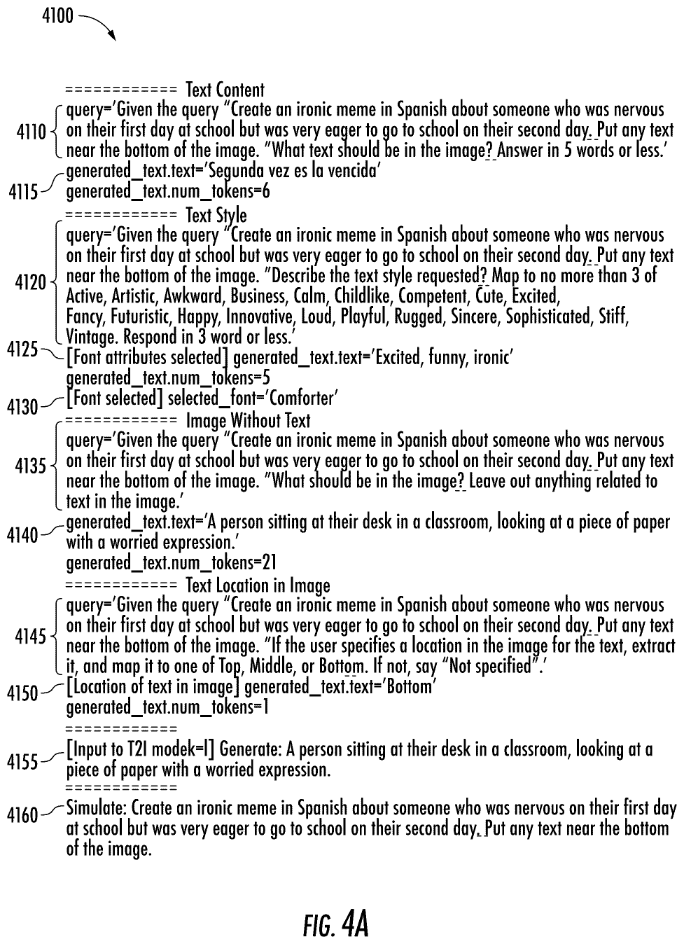

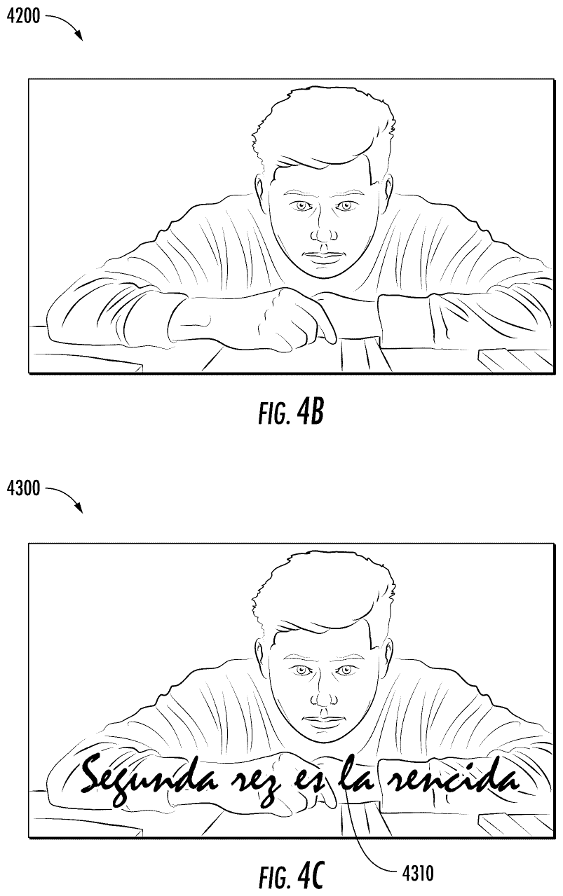

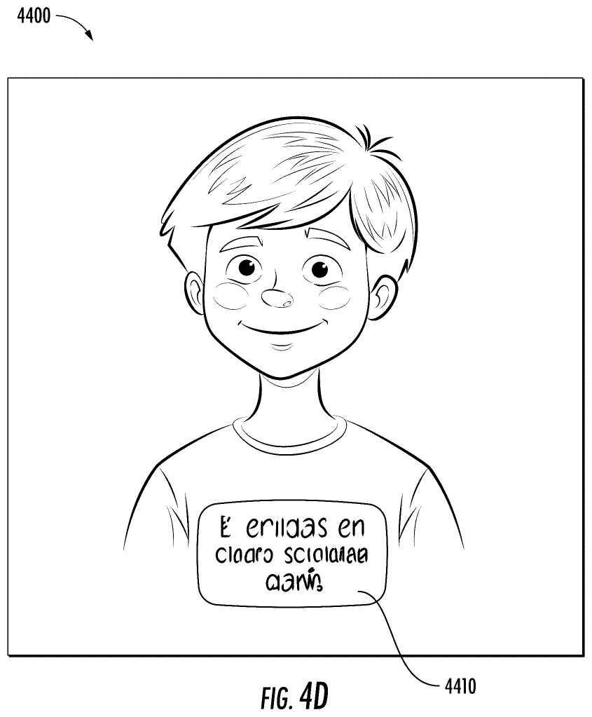

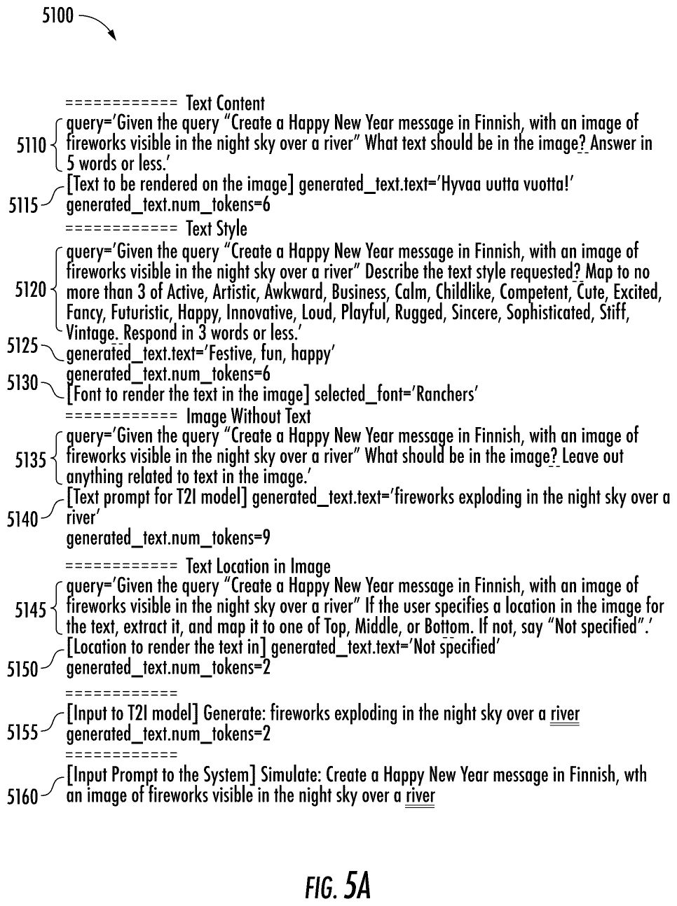

FIGS. 4A-4C are example implementations of the method for generating content including an image and text based on an input prompt, by implementing a plurality of machine-learned models, according to one or more example embodiments of the disclosure. FIG. 4D is an example image generated according to an existing method, based on the same input prompt.

In FIG. 4A, an example implementation 4100 includes a first section 4110 which includes the query (input prompt) provided to the one or more first machine-learned models 3121 of “Create an ironic meme in Spanish about someone who was nervous on their first day at school but was very eager to go to school on their second day. Put any text near the bottom of the image,” and a prompt to the one or more first machine-learned models 3121 to determine “What text should be in the image? Answer in 5 words or less.”.

FIG. 4A depicts a second section 4115 which includes the generated output text from the one or more first machine-learned models 3121 in the translated target language (Spanish) of “Segunda vez es la vencida” (e.g., a translation of “Second time is the charm”).

FIG. 4A depicts a third section 4120 which includes the query and another prompt to the one or more first machine-learned models 3121 to determine the text style (e.g., given the query, “describe the text style requested? Map to no more than 3 of Active, Artistic, Awkward, Business, Calm, Childlike, Competent, Cute, Excited, Fancy, Futuristic, Happy, Innovative, Loud, Playful, Rugged, Sincere, Sophisticated, Stiff, Vintage. Respond in 3 words or less”).

FIG. 4A depicts a fourth section 4125 which includes the generated output text from the one or more first machine-learned models 3121 identifying the attributes of the text style of “Excited, funny, ironic.”

FIG. 4A depicts a fifth section 4130 which includes the generated output font style from the font selector 3126 based on the identified text styles of “Comforter.”

FIG. 4A depicts a sixth section 4135 which includes the query and another prompt to the one or more first machine-learned models 3121 to determine the second features from the input prompt that should be used to form a prompt for the one or more second machine-learned models 3127 to generate the initial image, by not including information relating to the text to be displayed in the final output image (e.g., given the query, “what should be in the image? Leave out anything related to text in the image”).

FIG. 4A depicts a seventh section 4140 which includes the generated output (a textual description) from the one or more first machine-learned models 3121 based on the prompt described with respect to the sixth section 4135. The generated output (textual description) can be used to generate the prompt to be provided to the one or more second machine-learned models 3127 for generating the initial image 3128. In the example of FIG. 4A, the output prompt textual description is: “A person sitting at their desk in a classroom, looking at a piece of paper with a worried expression.”

FIG. 4A depicts an eighth section 4145 which includes the query and another prompt to the one or more first machine-learned models 3121 to determine the location of the text to be placed in the final output image (e.g., given the query, “if the user specifies a location in the image for the text, extract it, and map it to one of Top, Middle, or Bottom. If not, say “Not specified”).

FIG. 4A depicts a ninth section 4150 which includes the generated location determination from the one or more first machine-learned models 3121 identifying the location in the final output image in which the text is to be placed (e.g., “Bottom”).

FIG. 4A depicts a tenth section 4155 which includes the prompt as described with respect to the sixth section 4135 and seventh section 4140 which is provided to the one or more second machine-learned models 3127 (e.g., a text-to-image machine-learned model). In the example of FIG. 4A, the prompt provided to the one or more second machine-learned models 3127 is: “Generate a person sitting at their desk in a classroom, looking at a piece of paper with a worried expression.”

FIG. 4A depicts an eleventh section 4160 which includes the input prompt to the computing system 3100 (e.g., a content generation system) for simulating and training the machine-learned models of the disclosed content generation system (e.g., via the content generation application 3120). In the example of FIG. 4A, the input prompt provided to the computing system 3100 (e.g., a content generation system) is: “Simulate: Create an ironic meme in Spanish about someone who was nervous on their first day at school but was very eager to go to school on their second day. Put any text near the bottom of the image.”

In the example implementation, FIG. 4B depicts the initial image 4200 which is generated via the one or more second machine-learned models 3127. In the example implementation, FIG. 4C depicts the final output image 4300 which is generated via the content renderer 3129 based on the initial image 4200 and the text “Segunda vez es la vencida” that is displayed near the bottom of the image according to the first features which are determined by the one or more first machine-learned models 3121.

By way of comparison, FIG. 4D depicts an example output image 4400 that is generated based on the same input prompt provided to the one or more first machine-learned models 3121 described with respect to FIGS. 4A-4C. As shown in FIG. 4D, the output image 4400 includes text 4410, however the generated text 4410 is nonsensical. Therefore, the disclosed method demonstrates an improvement over an existing method by providing accurate text that satisfies the expectations of the user. Further, while the example of FIGS. 4A-4C illustrate an image being generated, for example via the computing system 3100 of FIG. 3A, the image could also be an image frame forming a part of a video generated via the computing system 3200 of FIG. 3B.

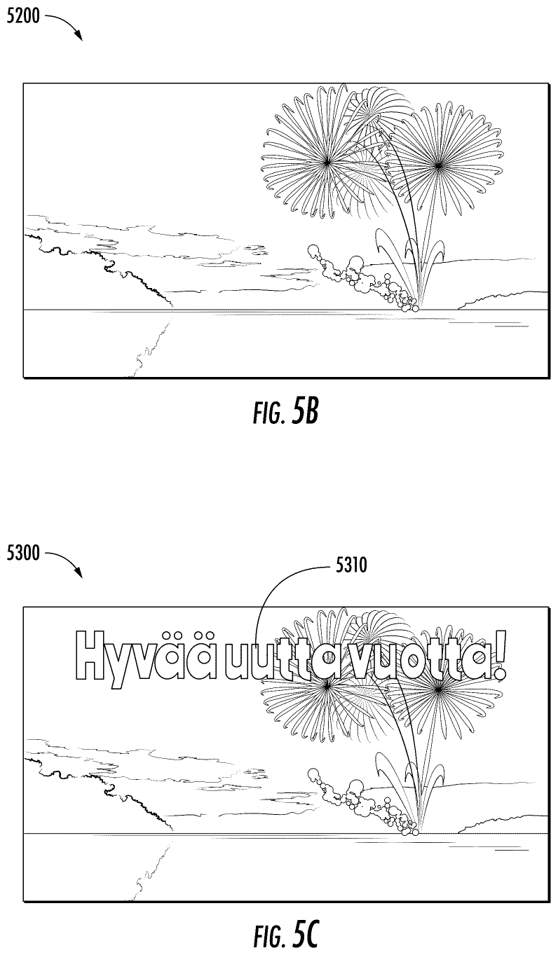

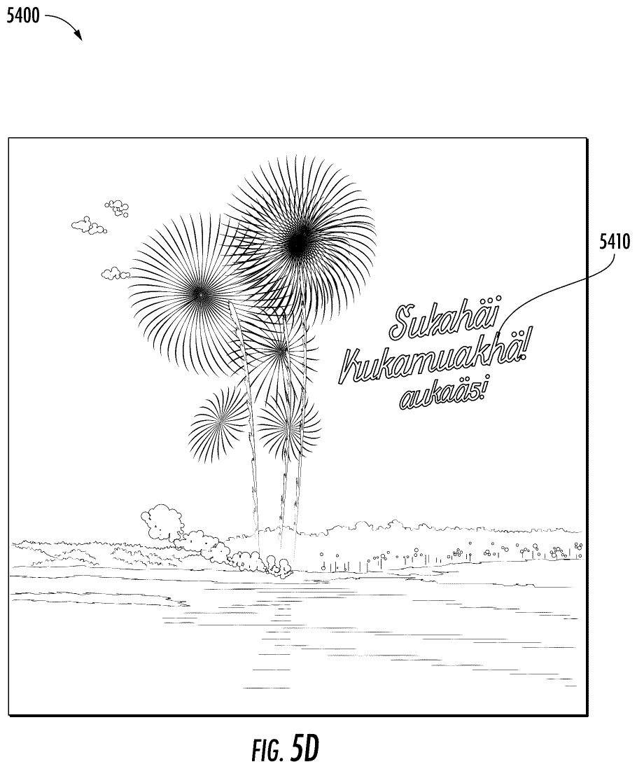

FIGS. 5A-5C are example implementations of the method for generating content including an image and text based on an input prompt, by implementing a plurality of machine-learned models, according to one or more example embodiments of the disclosure. FIG. 5D is an example image generated according to an existing method, based on the same input prompt.

In FIG. 5A, an example implementation 5100 includes a first section 5110 which includes the query (input prompt) provided to the one or more first machine-learned models 3121 of “Create a Happy New Year message in Finnish, with an image of fireworks visible in the night sky over a river,” and a prompt to the one or more first machine-learned models 3121 to determine “What text should be in the image? Answer in 5 words or less.”.

FIG. 5A depicts a second section 5115 which includes the generated output text from the one or more first machine-learned models 3121 in the translated target language (Finnish) of “Hyvää uutta vuotta!”

FIG. 5A depicts a third section 5120 which includes the query and another prompt to the one or more first machine-learned models 3121 to determine the text style (e.g., given the query, “describe the text style requested? Map to no more than 3 of Active, Artistic, Awkward, Business, Calm, Childlike, Competent, Cute, Excited, Fancy, Futuristic, Happy, Innovative, Loud, Playful, Rugged, Sincere, Sophisticated, Stiff, Vintage. Respond in 3 words or less”).

FIG. 5A depicts a fourth section 5125 which includes the generated output text from the one or more first machine-learned models 3121 identifying the attributes of the text style of “Festive, fun, happy.”

FIG. 5A depicts a fifth section 5130 which includes the generated output font style from the font selector 3126 based on the identified text styles of “Ranchers.”

FIG. 5A depicts a sixth section 5135 which includes the query and another prompt to the one or more first machine-learned models 3121 to determine the second features from the input prompt that should be used to form a prompt for the one or more second machine-learned models 3127 to generate the initial image, by not including information relating to the text to be displayed in the final output image (e.g., given the query, “what should be in the image? Leave out anything related to text in the image”).

FIG. 5A depicts a seventh section 5140 which includes the generated output (a textual description) from the one or more first machine-learned models 3121 based on the prompt described with respect to the sixth section 5135. The generated output (textual description) can be used to generate the prompt to be provided to the one or more second machine-learned models 3127 for generating the initial image 3128. In the example of FIG. 5A, the output prompt textual description is: “fireworks exploding in the night sky over a river.”

FIG. 5A depicts an eighth section 5145 which includes the query and another prompt to the one or more first machine-learned models 3121 to determine the location of the text to be placed in the final output image (e.g., given the query, “if the user specifies a location in the image for the text, extract it, and map it to one of Top, Middle, or Bottom. If not, say “Not specified”).

FIG. 5A depicts a ninth section 5150 which includes the generated location determination from the one or more first machine-learned models 3121 identifying the location in the final output image in which the text is to be placed (e.g., “Not specified”).

FIG. 5A depicts a tenth section 5155 which includes the prompt as described with respect to the sixth section 5135 and seventh section 5140 which is provided to the one or more second machine-learned models 3127 (e.g., a text-to-image machine-learned model). In the example of FIG. 5A, the prompt provided to the one or more second machine-learned models 3127 is: “Generate fireworks exploding in the night sky over a river.”

FIG. 5A depicts an eleventh section 5160 which includes the input prompt to the computing system 3100 (e.g., a content generation system) for simulating and training the machine-learned models of the disclosed content generation system (e.g., via the content generation application 3120). In the example of FIG. 5A, the input prompt provided to the computing system 3100 (e.g., a content generation system) is: “Simulate: Create a Happy New Year message in Finnish, with an image of fireworks visible in the night sky over a river.”

In the example implementation, FIG. 5B depicts the initial image 5200 which is generated via the one or more second machine-learned models 3127. In the example implementation, FIG. 5C depicts the final output image 5300 which is generated via the content renderer 3129 based on the initial image 5200 and the text “Hyvää uutta vuotta!” that is displayed at a default location or at a location appropriate based on the attributes of the initial image 5200 (e.g., near the top of the image).

By way of comparison, FIG. 5D depicts an example output image 5400 that is generated based on the same input prompt provided to the one or more first machine-learned models 3121 described with respect to FIGS. 5A-5C. As shown in FIG. 5D, the output image 5400 includes text 5410, however the generated text 5410 is not in the Finnish language. Therefore, the disclosed method demonstrates an improvement over an existing method by providing accurate text that satisfies the expectations of the user. Further, while the example of FIGS. 5A-5C illustrate an image being generated, for example via the computing system 3100 of FIG. 3A, the image could also be an image frame forming a part of a video generated via the computing system 3200 of FIG. 3B.

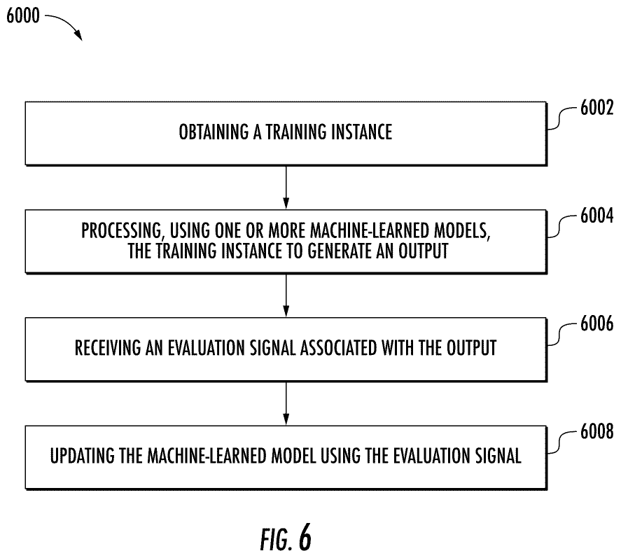

FIG. 6 depicts a flowchart of a method 6000 for training one or more machine-learned models according to aspects of the disclosure. For instance, an example machine-learned model can include one or more of a LLM, a generative machine-learned model, etc. For example, the one or more machine-learned models may be configured to implement the operations of FIGS. 2A-2B, of the content generation applications as described herein.

FIG. 6 is a flow chart diagram illustrating an example method for training a machine-learned model according to example implementations of aspects of the disclosure. One or more portion(s) of example method 6000 can be implemented by a computing system that includes one or more computing devices such as, for example, computing systems described with reference to the other drawings. Each respective portion of example method 6000 can be performed by any (or any combination) of one or more computing devices. Moreover, one or more portion(s) of example method 6000 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 6 is described with reference to elements/terms described with respect to other systems and drawings for exemplary illustrated purposes and is not meant to be limiting. One or more portions of example method 6000 can be performed additionally, or alternatively, by other systems.

At 6002, example method 6000 can include obtaining a training instance. A set of training data can include a plurality of training instances divided between multiple datasets (e.g., a training dataset, a validation dataset, or testing dataset). A training instance can be labeled or unlabeled. Although referred to in example method 6000 as a “training” instance, it is to be understood that runtime inferences can form training instances when a model is trained using an evaluation of the model's performance on that runtime instance (e.g., online training/learning). Example data types for the training instance and various tasks associated therewith are described throughout the disclosure.

At 6004, example method 6000 can include processing, using one or more machine-learned models, the training instance to generate an output. The output can be directly obtained from the one or more machine-learned models or can be a downstream result of a chain of processing operations that includes an output of the one or more machine-learned models.

At 6006, example method 6000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 6008, example method 6000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 6000 can include implementing a number of generalization techniques (e.g., weight decays, dropouts, etc.) to improve the generalization capability of the models being trained.

In some implementations, example method 6000 can be implemented for training a machine-learned model from an initialized state to a fully trained state (e.g., when the model exhibits a desired performance profile, such as based on accuracy, precision, recall, etc.).

In some implementations, example method 6000 can be implemented for particular stages of a training procedure. For instance, in some implementations, example method 6000 can be implemented for pre-training a machine-learned model. Pre-training can include, for instance, large-scale training over potentially noisy data to achieve a broad base of performance levels across a variety of tasks/data types. In some implementations, example method 6000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

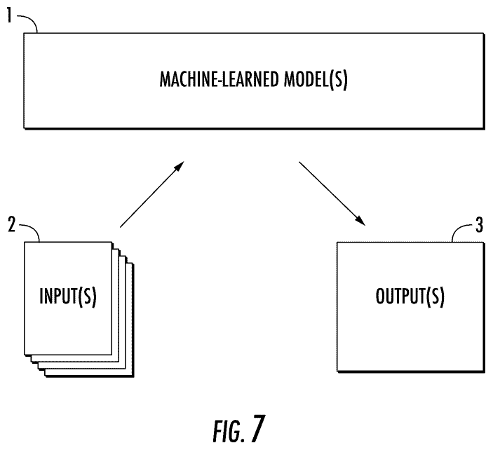

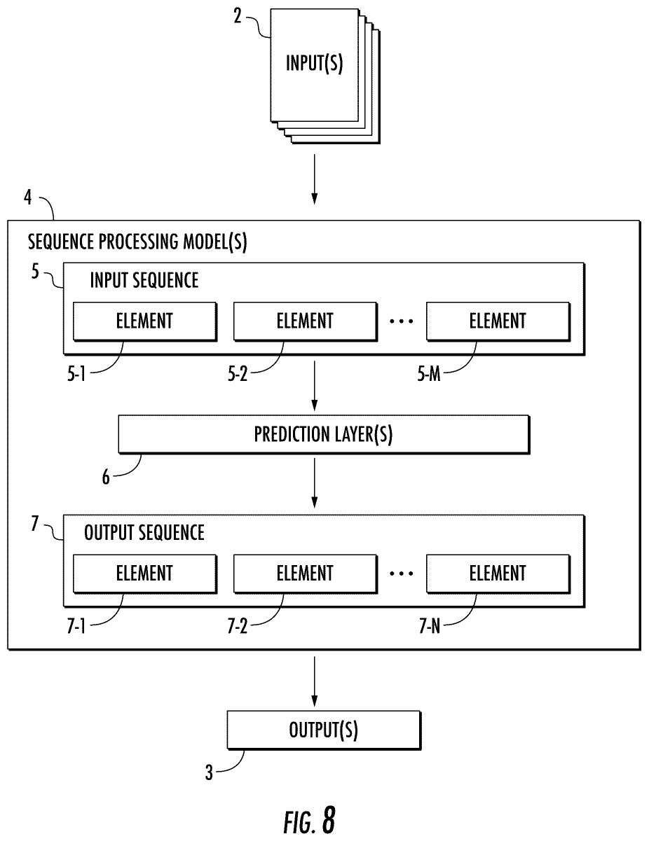

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the disclosure are not limited to those examples noted above.

### Example Machine-Learned Sequence Processing Models

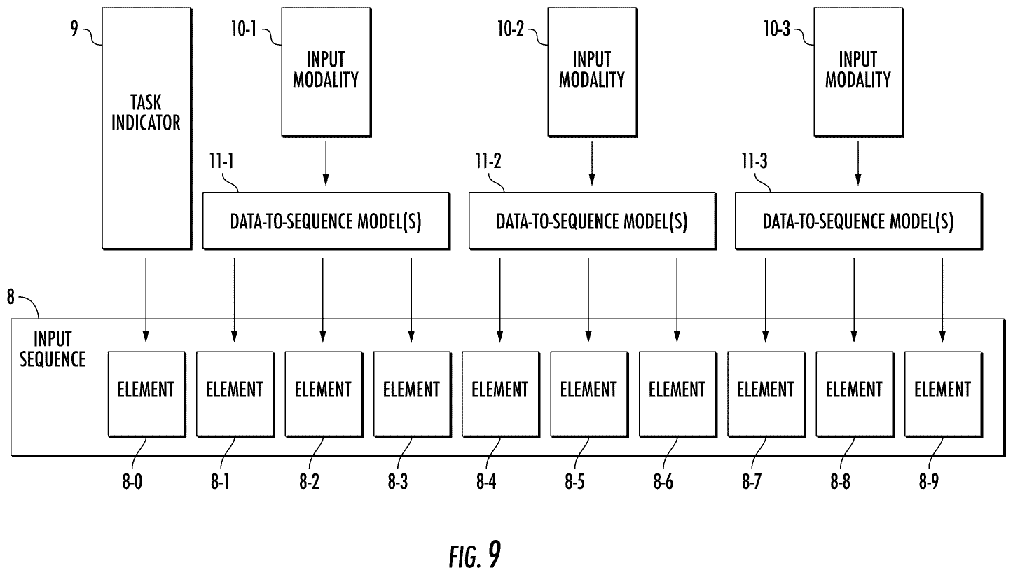

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

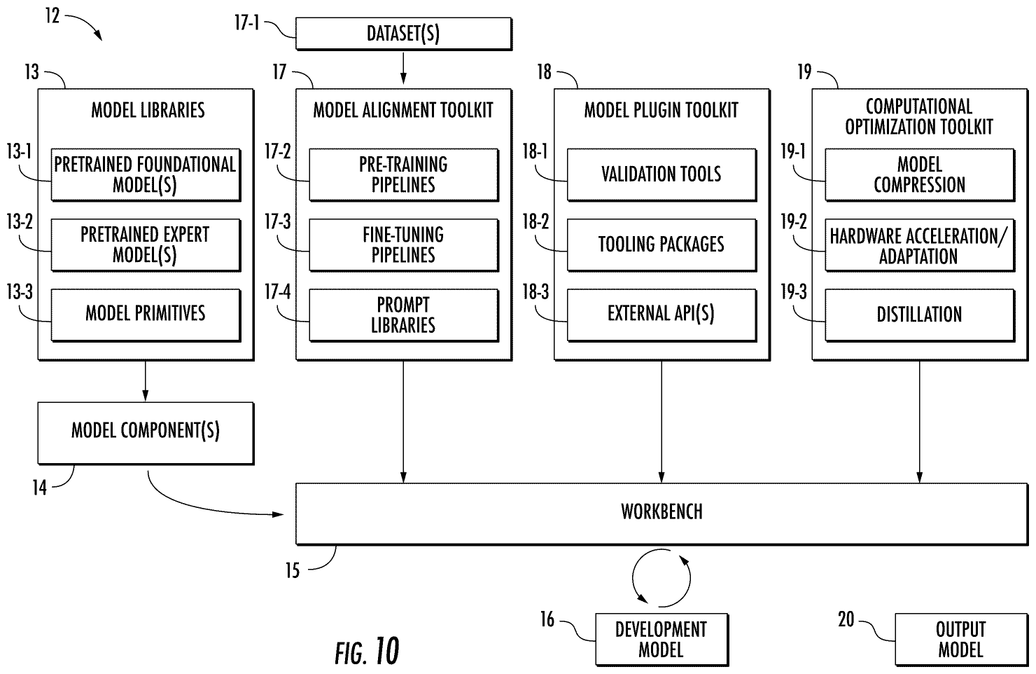

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

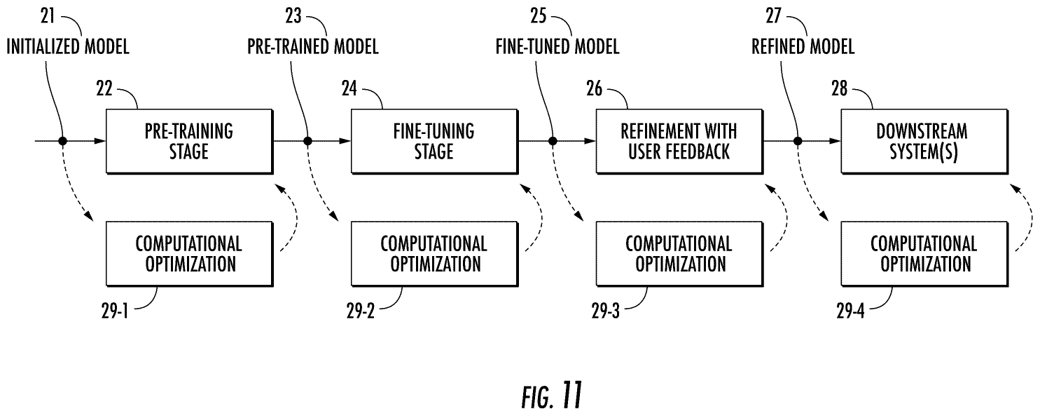

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data.

Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 6000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

FIG. 11 is a block diagram of an example training flow for training a machine-learned development model 16. One or more portion(s) of the example training flow can be implemented by a computing system that includes one or more computing devices such as, for example, computing systems described with reference to the other drawings. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 11 is described with reference to elements/terms described with respect to other systems and drawings for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

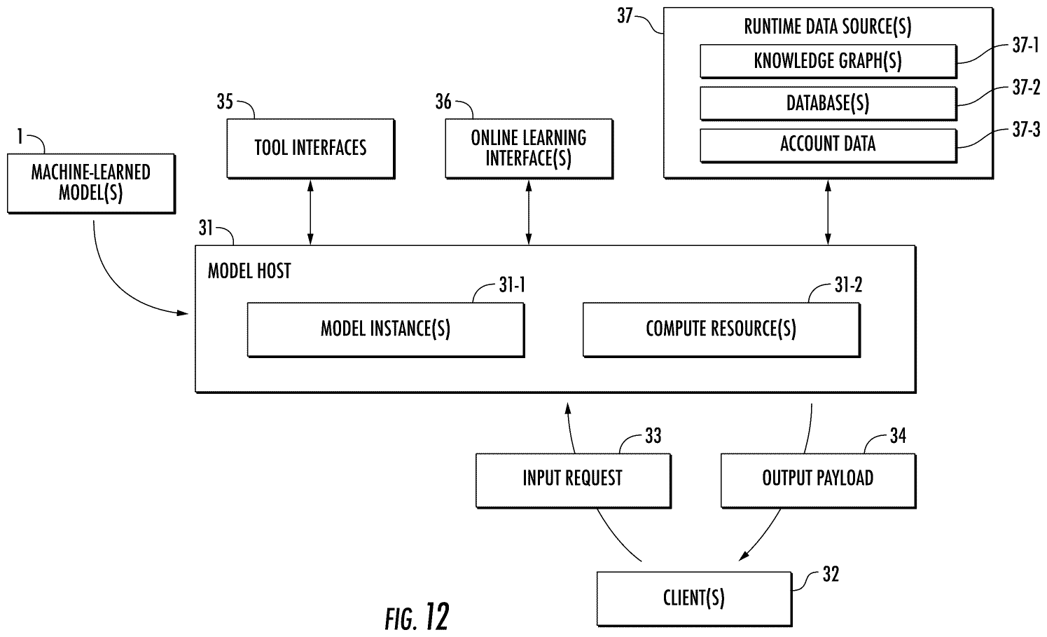

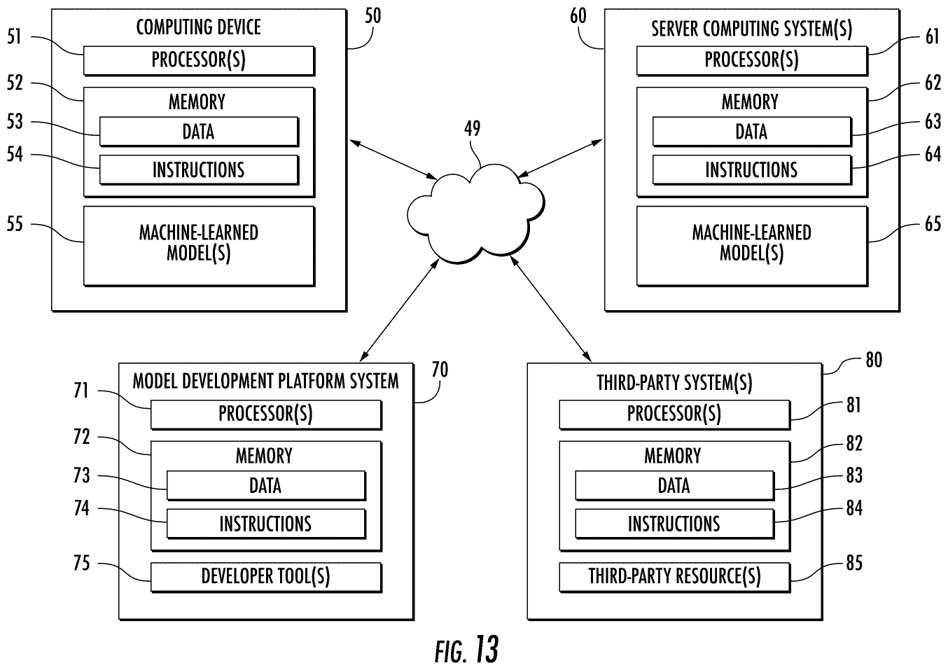

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

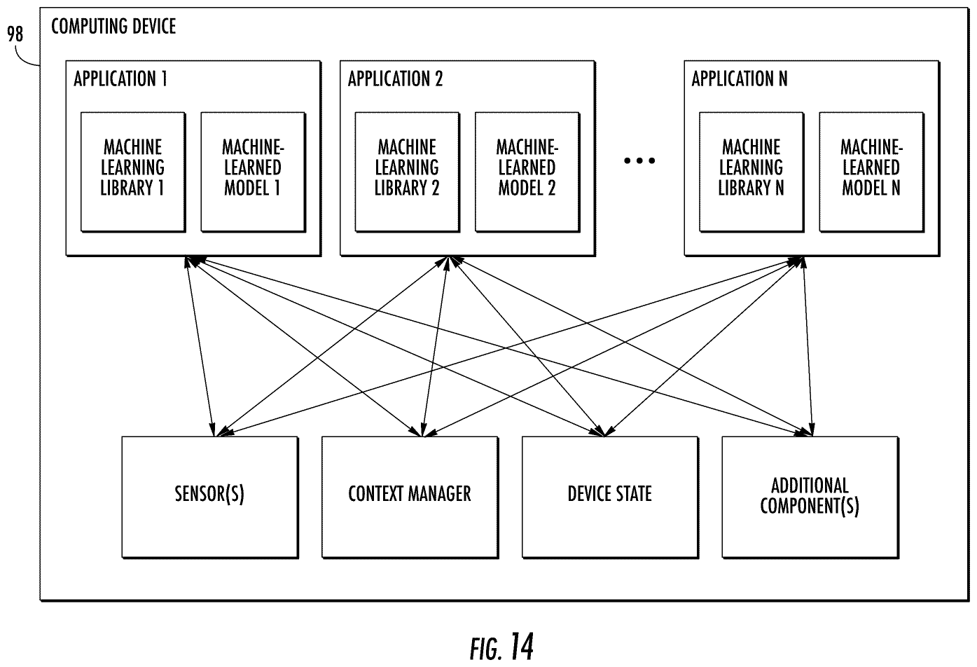

FIG. 13 is a block diagram of an example networked computing system that can perform aspects of example implementations of the disclosure. The system can include a number of computing devices and systems that are communicatively coupled over a network 49. An example computing device 50 is described to provide an example of a computing device that can perform any aspect of the disclosure (e.g., implementing model host 31, client(s) 32, or both). An example server computing system 60 is described as an example of a server computing system that can perform any aspect of the disclosure (e.g., implementing model host 31, client(s) 32, or both). Computing device 50 and server computing system(s) 60 can cooperatively interact (e.g., over network 49) to perform any aspect of the disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein.

Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

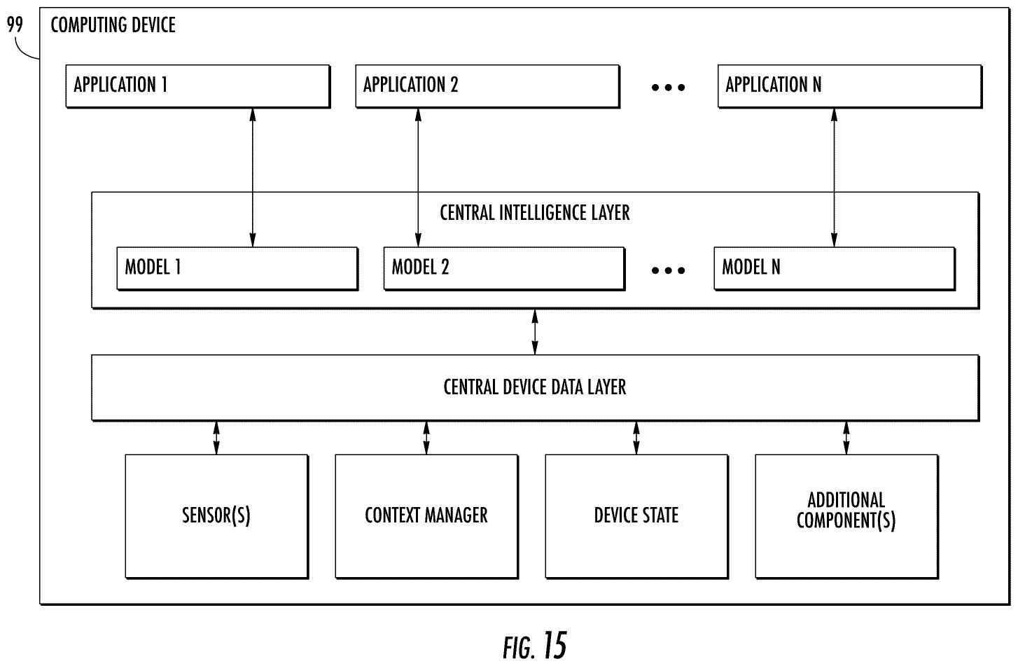

FIG. 14 is a block diagram of an example computing device 98 that performs according to example embodiments of the disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a content generation application, a text messaging application, an email application, a dictation application, a virtual keyboard application, a browser application, a social media application, a chat application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a content generation application, a text messaging application, an email application, a dictation application, a virtual keyboard application, a browser application, a social media application, a chat application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, numbers, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computing device, comprising:
one or more memories configured to store instructions; and
one or more processors configured to execute the instructions to perform operations, the operations comprising:
receiving an input prompt requesting to generate content including an image with text;
implementing one or more first machine-learned models configured to:
determine, based on the input prompt, the text to be displayed in the image and one or more first features associated with the text, and
determine one or more second features relating to generating an initial image which excludes the text;
implementing one or more second machine-learned models configured to generate the initial image based on the one or more second features; and
generating the content including the image with the text, based on the initial image generated via the one or more second machine-learned models and the one or more first features associated with the text.

2. The computing device of claim 1, wherein the input prompt includes a request to display the text in a target language which is in a different language than the input prompt.

3. The computing device of claim 2, wherein the one or more first machine-learned models are configured to determine the target language based on the input prompt and to convert the text to the target language.

4. The computing device of claim 1, wherein the one or more first features associated with the text include at least one of:
one or more text colors associated with the text,
one or more text locations associated with the text, or
one or more text styles associated with the text.

5. The computing device of claim 1, wherein
the one or more first features include one or more text styles associated with the content, and
the operations further comprise determining one or more font types associated with the text based on the one or more text styles.

6. The computing device of claim 5, wherein
the one or more first machine-learned models are configured to determine the one or more text styles based on portions of the input prompt which indicate at least one of a tone, theme, or purpose of the content to be generated, and
the one or more first machine-learned models are configured to limit a number of the one or more text styles determined by the one or more first machine-learned models to a predetermined number of text styles.

7. The computing device of claim 1, wherein
the one or more first features include one or more text locations associated with the text, and
the one or more first machine-learned models are configured to determine whether the input prompt indicates the one or more text locations at which to position the text within the image.

8. The computing device of claim 7, wherein
when the one or more first machine-learned models determine the input prompt indicates the one or more text locations to position the text within the image, the one or more first machine-learned models are configured to determine the one or more second features include the one or more text locations, and
the one or more second machine-learned models are configured to generate the initial image by positioning one or more entities within the initial image based on the one or more text locations.

9. The computing device of claim 7, wherein
when the one or more first machine-learned models determine the input prompt indicates the one or more text locations to position the text within the image, the one or more first machine-learned models are configured to determine the one or more second features include the one or more text locations, and
the one or more second machine-learned models are configured to generate the initial image by colorizing at least a portion of the initial image based on the one or more text locations.

10. The computing device of claim 7, wherein when the one or more first machine-learned models determine the input prompt does not indicate the one or more text locations to position the text within the image, the one or more first machine-learned models are configured to determine the one or more text locations based on the initial image generated by the one or more second machine-learned models.

11. The computing device of claim 7, wherein the one or more first machine-learned models are configured to determine the one or more text locations based on at least one of a location of one or more entities appearing in the initial image or a colorization of the initial image.

12. The computing device of claim 7, wherein when the one or more first machine-learned models determine the input prompt does not indicate the one or more text locations to position the text within the image, the one or more first machine-learned models are configured to position the text at a default location within the image.

13. The computing device of claim 1, wherein
the one or more first machine-learned models are configured to determine whether the input prompt indicates one or more text colors to apply to the text within the image, and
when the one or more first machine-learned models determine the input prompt indicates the one or more text colors to apply to the text within the image, the one or more first machine-learned models determine the one or more first features include the one or more text colors to apply to the text within the image.

14. The computing device of claim 13, wherein
when the one or more first machine-learned models determine the input prompt indicates the one or more text colors to apply to the text within the image, the one or more first machine-learned models are configured to determine the one or more second features include the one or more text colors, and
the one or more second machine-learned models are configured to generate the initial image by colorizing at least a portion of the initial image based on the one or more text colors.

15. The computing device of claim 13, wherein
when the one or more first machine-learned models determine the input prompt does not indicate the one or more text colors to apply to the text within the image, the one or more first machine-learned models are configured to determine the one or more text colors to apply to the text within the image, based on the initial image generated by the one or more second machine-learned models, and
the one or more first machine-learned models determine the one or more first features include the one or more text colors to apply to the text within the image.

16. The computing device of claim 1, wherein
the one or more first machine-learned models include one or more text-to-text machine-learned models, and
the one or more second machine-learned models include one or more text-to-image machine-learned models.

17. A computer-implemented method, comprising:
receiving an input prompt requesting to generate content including an image with text;
implementing one or more first machine-learned models to:
determine, based on the input prompt, the text to be displayed in the image and one or more first features associated with the text, and
determine one or more second features relating to generating an initial image which excludes the text;
implementing one or more second machine-learned models to generate the initial image based on the one or more second features; and
generating the content including the image with the text, based on the initial image generated via the one or more second machine-learned models and the one or more first features associated with the text.

18. The computer-implemented method of claim 17, further comprising:
implementing the one or more first machine-learned models to determine, based on the input prompt, a target language in which to display the text in the image, and to convert the text to the target language.

19. The computer-implemented method of claim 17, further comprising:
determining, one or more text styles based on portions of the input prompt which indicate at least one of a tone, theme, or purpose of the content to be generated; and
determining one or more font types associated with the text based on the one or more text styles, wherein the one or more first features include the one or more text styles and the one or more font types.

20. A non-transitory computer readable medium storing instructions which, when executed by a processor, cause the processor to perform operations, the operations comprising:
receiving an input prompt requesting to generate content including an image with text;
implementing one or more first machine-learned models to:
determine, based on the input prompt, the text to be displayed in the image and one or more first features associated with the text, and
determine one or more second features relating to generating an initial image which excludes the text;
implementing one or more second machine-learned models to generate the initial image based on the one or more second features; and
generating the content including the image with the text, based on the initial image generated via the one or more second machine-learned models and the one or more first features associated with the text.
